(19) United States
(12) Patent Application Publication
(10) Pub. No.: US 2016/0197684 A1
(43) Pub. Date: Jul. 7, 2016

(54) RF TESTING SYSTEM WITH SERDES DEVICE

(71) Applicant: MediaTek Inc., Hsin-Chu (TW)

(72) Inventors: Chung-Chin TSAI, Taichung City (TW); Chun-Hsien PENG, Xinyi Township (TW); Yuan-Hwui CHUNG, Tainan City (TW)

(21) Appl. No.: 15/071,536

(22) Filed: Mar. 16, 2016

Related U.S. Application Data
(63) Continuation-in-part of application No. 14/696,807, filed on Apr. 27, 2015.
Application No. 14/696,807 is a continuation of application No. 14/054,213, filed on Oct. 15, 2013, now abandoned.
Application No. 14/054,213 is a continuation-in-part of application No. 13/480,969, filed on May 25, 2012, now Pat. No. 9,041,421.
(60) Provisional application No. 62/135,325, filed on Mar. 19, 2015.
(60) Provisional application No. 61/731,845, filed on Nov. 30, 2012.
(60) Provisional application No. 61/496,451, filed on Jun. 13, 2011.

(51) Int. Cl. H04B 17/00; H04B 17/29

(52) U.S. Cl. CPC H04B 17/0085; H04B 17/29

(57) ABSTRACT

An integrated circuit (IC) is provided. The IC includes: a controller, a serializer-deserializer (SerDes) device, a transmitter, and a receiver. The controller is configured to obtain a test signal when the IC has entered a test mode. The SerDes device is configured to perform a serialization/deserialization process on the test signal. The transmitter is configured to generate a radio frequency (RF) signal in response to the test signal after the serialization/deserialization process. The RF receiver is configured to receive the RF signal in the test mode. The controller further captures the received RF signal from the receiver for determining a test result.

### CROSS REFERENCE TO RELATED APPLICATIONS

This application claims the benefit of U.S. Provisional Application No. 62/135,325, filed on Mar. 19, 2015. This application is also a Continuation-In-Part of application Ser. No. 14/696,807, filed on Apr. 27, 2015, which is a Continuation of U.S. patent application Ser. No. 14/054,213, filed on Oct. 15, 2013, which claims benefit of U.S. Provisional Application No. 61/731,845, filed on Nov. 30, 2012. Application Ser. No. 14/696,807 is also a Continuation-In-Part of U.S. patent application Ser. No. 13/480,969, filed on May 25, 2012 (now U.S. Pat. No. 9,041,421), which claims the benefit of provisional Application No. 61/496,451, filed on Jun. 13, 2011, the entirety of which are incorporated by reference herein.

### BACKGROUND OF THE INVENTION

1. Field of the Invention

The present invention relates to semiconductor devices, and in particular to radio frequency (RF) testing systems for semiconductor devices.

2. Description of the Related Art

Semiconductor devices are manufactured in the form of wafers comprising many thousands of devices. The wafers are diced into dies and packaged into integrated circuits (IC). Each IC has been implemented by integrating more and more digital and analog circuits into a single chip.

Due to the increasing complexity of the testing of integrated RF circuits, to identify the “good” and “bad” ICs during production is a challenging problem for those conducting the wafer-level test or final test. In the traditional testing of RF circuits, what is used is expensive automatic test equipment (ATE), such as UltraFlex or Flex with RF instruments, or equipment used in mixing signals is used for generating an RF test signal (or RF patterns) to a device under test (DUT) and processing RF signals emanating from the DUT, leading to increased cost and time to conduct the tests.

A SerDes or serializer/deserializer is an integrated circuit (IC or chip) transceiver that converts parallel data to serial data and vice-versa. The transmitter section (e.g. serializer) converts an n-bit parallel bus into a differential serial stream, and the receiver section (e.g. deserializer) converts a differential serial stream into an n-bit parallel bus. SerDes chips facilitate the transmission of parallel data between two points over serial streams, reducing the number of data paths and thus the number of connecting pins or wires required. Most SerDes devices are capable of full-duplex operation, meaning that data conversion can take place in both directions simultaneously. SerDes chips are used in Gigabit Ethernet systems, wireless network routers, fiber optic communications systems, and storage applications. Specifications and speeds vary depending on the needs of the user and on the application. SerDes devices are capable of operating at speeds in excess of 10 Gbps.

Conventionally, the RF circuits and the SerDes circuits are tested (e.g., identified as good or bad) separately. For an integrated circuit having both RF circuit(s) and SerDes circuit(s), there is a need for an effective and cost-saving RF test technique.

### BRIEF SUMMARY OF THE INVENTION

A detailed description is given in the following embodiments with reference to the accompanying drawings.

In an exemplary embodiment, an integrated circuit (IC) is provided. The IC includes: a controller, a serializer-deserializer (SerDes) device, a transmitter, and a receiver. The controller is configured to obtain a test signal when the IC has entered a test mode. The SerDes device is configured to perform a serialization/deserialization process on the test signal. The transmitter is configured to generate a radio frequency (RF) signal in response to the test signal after the serialization/deserialization process. The RF receiver is configured to receive the RF signal in the test mode. The controller further captures the received RF signal from the receiver for determining a test result.

In another exemplary embodiment, a radio frequency (RF) testing system is provided. The RF testing system includes: test equipment, module circuitry, and an integrated circuit. The test equipment is configured to generate a test signal. The IC includes: a controller, configured to obtain the test signal from the module circuitry when the IC has entered a test mode; a serializer-deserializer (SerDes) device, configured to perform a serialization/deserialization process on the test signal; a transmitter, configured to generate an outgoing radio frequency (RF) signal in response to the test signal after the serialization/deserialization process; and a receiver, configured to receive the outgoing RF signal in the test mode. The controller further captures the received outgoing RF signal from the RF receiver for determining a test result, and the module circuitry is external to the IC and the test equipment.

### BRIEF DESCRIPTION OF THE DRAWINGS

The present invention can be more fully understood by reading the subsequent detailed description and examples with references made to the accompanying drawings, wherein:

FIG. 1 is a block diagram of a conventional radio frequency (RF) testing system 1;

FIG. 2 is a block diagram of an RF built-in-self-test (BIST) system 2 according to an embodiment of the invention;

FIG. 3 is a block diagram of an RF BIST system 3 according to another embodiment of the invention;

FIG. 4 is a block diagram of an RF BIST system 4 according to another embodiment of the invention;

FIG. 5 is a block diagram of an RF BIST system 5 according to yet another embodiment of the invention;

FIG. 6 is a block diagram of an RF BIST system 6 according to still yet another embodiment of the invention; and

FIG. 7 is a block diagram of an RF BIST system 7 according to yet another embodiment of the invention;

FIG. 8 is a simplified schematic block diagram of an RF testing system 3008 according to an embodiment of the invention;

FIG. 9 is a detailed schematic block diagram of an RF testing system 3009 according to an embodiment of the invention;

FIG. 10 is a detailed schematic block diagram of the RF testing system 3010 according to another embodiment of the invention;

FIGS. 11A-11B are schematic block diagrams of the signal converter 330 according to different embodiments of the invention;

FIG. 12 is a detailed schematic block diagram of the RF testing system 3012 according to yet another embodiment of the invention;

FIG. 13 is a detailed schematic block diagram of the RF testing system 3013 according to still yet another embodiment of the invention;

FIG. 14A-4C are block diagrams of the external source generator 310 according to different embodiments of the invention;

FIG. 15 is a schematic block diagram of an RF testing system 3015 according to an embodiment of the invention;

FIG. 16 is a schematic block diagram of an RF testing system 3016 according to another embodiment of the invention;

FIG. 17 is a schematic block diagram of an RF testing system 3017 according to yet another embodiment of the invention;

FIG. 18 is a schematic block diagram of an RF testing system 3018 according to still yet another embodiment of the invention;

FIG. 19 is a schematic block diagram of an RF testing system 3019 according to still another embodiment of the invention; and

FIG. 20 is a schematic block diagram of an RF testing system 3020 according to still another embodiment of the invention;

FIG. 21 is a diagram of an RF testing system in accordance with an embodiment of the invention;

FIG. 22 is a diagram illustrating different test configurations the RF testing system 1500 in FIG. 21;

FIG. 23 is a diagram of an RF testing system in accordance with another embodiment of the invention;

FIG. 24 is a diagram of an RF testing system in accordance with another embodiment of the invention;

FIG. 25 is a diagram illustrating different test configurations the RF testing system 1900 in accordance with another embodiment of the invention;

FIG. 26 is a diagram illustrating different test configurations the RF testing system 1900 in accordance with yet another embodiment of the invention; and

FIG. 27 is a diagram illustrating different test configurations the RF testing system 1900 in accordance with yet another embodiment of the invention;

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

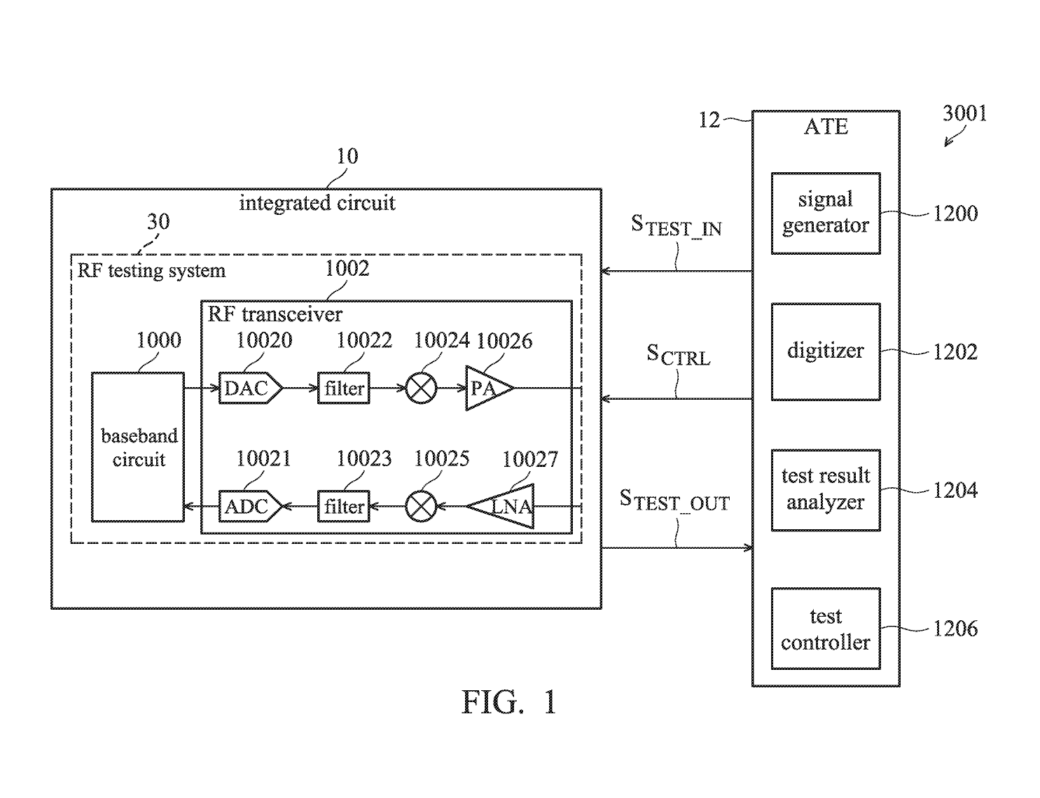

FIG. 1 is a block diagram of a conventional radio frequency (RF) testing system 3001. As illustrated in FIG. 1, the RF testing system 3001 comprises an integration circuit (IC) 10 and automatic test equipment (ATE) 12. The ATE 12 applies semiconductor testing for digital and analog elements in the IC 10 during the hardware manufacturing procedure. The IC 10 is a device under test (DUT) that receives power and testing patterns from the ATE 12 and outputs testing responses to the ATE 12. The ATE 12 is an electronic apparatus that receives a test program and performs tests accordingly on the DUT by supplying stimulus signals. The ATE 12 also receives outcome signals, takes signal measurements, evaluates test results based on the signal measurements, and determines whether the DUT is good or bad. The ATE 12 comprises a signal generator 1200, a digitizer 1202, a test result analyzer 1204 and a test controller 1206. The test controller 1206 sends a test control signal S_{CTRL} to control all the registers in the IC 10 by some digital or analog pins to operate under a test mode. The signal generator 1200 may provide an analog signal or/and RF signal (test pattern S_{TEST}_{_}_{IN}) to be injected into the IC 10 for the test of RF circuits. The digitizer 1202 digitizes an output response S_{TEST}_{_}_{OUT} from the IC 10 and converts analog signal or/and RF signal to digital signal. The test result analyzer 1204 analyzes the evaluated signal performance of the digitized signal to determine whether the DUT has any faulty components for the wafer-level test or final test.

The IC 10 in FIG. 1 includes an RF testing system 30, which comprises a baseband circuit 1000 and an RF transceiver 1002. The ATE 12 performs an RF test to the IC 10, particularly to all transceivers for various communication systems adopted by the IC 10 by feeding the analog or/and RF test pattern S_{TEST}_{_}_{IN} into the IC 10. The RF testing system 30 illustrates a transmitter path and receiver path, wherein the transmitter path comprising a digital-to-analog converter (DAC) 10020, a filter 10022, a modulator 10024, and a power amplifier (PA) 10026, and the receiver path comprising a low noise amplifier (LNA) 10027, a demodulator 10025, a filter 10023, and an analog-to-digital converter (ADC) 10021. For an RF test, the signal generator 1200 in the ATE 12 generates and injects a test pattern S_{TEST}_{_}_{IN} in high frequency to a testing interface (not shown) for testing the RF receiver in the RF testing system 30. The ATE 12 may further receive analog or/and RF signal S_{TEST}_{_}_{OUT} from the output of the transmitter path to evaluate the quality of transmitter of the IC 10.

In the conventional RF test, the ATE 12 supplies the analog or/and RF test pattern S_{TEST}_{_}_{IN} to the IC 10 and receives the analog or/and RF output response S_{TEST}_{_}_{OUT} from the IC 10, therefore there is high-speed communication between the ATE 12 and the IC 10, requiring the ATE 12 to work at a high speed, resulting in an increased cost of the ATE 12.

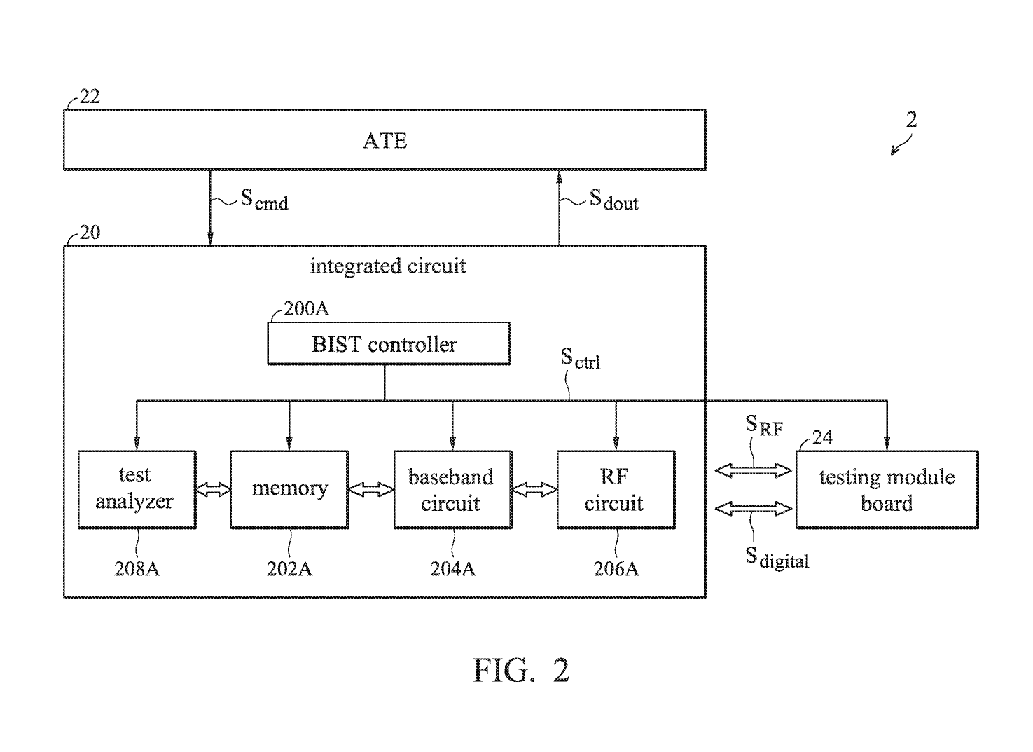

FIG. 2 is a block diagram of an RF BIST system 2 according to an embodiment of the invention, comprising an IC 20, an ATE 22, and a testing module board 24. The ATE 22 initializes an RF BIST by sending a command signal S_{cmd} to the IC 20. In response, the IC 20 is arranged to enter into a test mode, and, in contrast to the ATE 22 controlling the test process in the conventional approach, the IC 20 takes controls of the test operations, which aims to locate defected building elements in a mixed mode circuitry or an analog circuitry in the IC 20. Under the test mode, the IC 20 communicates with the testing module board 24 using RF signals S_{RF} and digital signals S_{digital}. The IC 20 may transmit RF signals S_{RF} to the testing module board 24 for transmission performance evaluation or receive RF signals S_{RF} from the testing module board 24, which is generated by the testing module board 24 itself or the IC 20 itself passing through the testing module board 24 using an external loopback path, to evaluate reception performance of the IC 20. The digital signals S_{digital} may be an evaluation signal produced and sent by the testing module board 24 to the IC 20 for a test analysis. The testing module board 24 is external to the IC 20 and ATE 22, comprises discrete components thereon to assist signal property analysis as well as RF testing signal generation and receive a control signal S_{ctrl} from the IC 20 in the test mode. In some implementations, an RF circuit 206A in the IC 20 may comprise RF transmitter to generate RF signal and RF receiver to receive RF signal from IC 20 itself by internal loopback path or testing module board 24. The quality of RF transmitter in RF circuit 206A may be evaluate by testing module board and/or IC 20 itself with a test analyzer 208A through internal or external loopback path. The RF receiver in RF circuit 206A also may be as a DUT to receive an RF signal from testing module board or IC 20 itself through internal or external loopback path and convert the RF signal to digital baseband signal. Consequently, the test analyzer 208A may be used to analyze captured digital signal saved in memory 202A and evaluate the quality of RF receive in RF circuit 206A.

The ATE 22 is capable of initiating various RF BISTs to the IC 20, including a single tone or one-tone test, a two-tone test, a multi-tone test, a noise figure (NF) test, a lock time test, a modulation test, etc. The ATE 22 may send the command signal or digital pattern S_{cmd} informing the IC 20 of the type of the BIST that is to perform, so that the IC 20 can load corresponding test patterns internally according to the command signal S_{cmd}. The ATE 22 may transmit the digital pattern S_{cmd} initiating one or more RF BIST types to IC 20.

The IC 20 in FIG. 2, comprises a BIST controller 200, a test analyzer 202A, a memory module 204A, a baseband circuit 206A, and an RF circuit 206A.

The BIST controller 200A is internally coupled to the memory module 202, the baseband circuit 204A, the RF circuit 206A, and a test analyzer 208A, and externally coupled to the testing module board 24 to take control of the test operations through the control signal S_{ctrl}. The control signal S_{ctrl} is a baseband signal having a frequency close to zero, and may be in digital or analog form. The BIST controller 200A controls the testing module board 24 to operate under the test mode through the control signal S_{ctrl}.

The memory module 202A and the baseband circuit 204A may be implemented as a signal generator, which is programmed to sequentially perform various tests by producing and injecting the test patterns into the RF circuit 206A for the tests including the one-tone test, the two-tone test, the multi-tone test, the NF test, the lock time test, the modulation test, etc. In some implementations, the memory module 202A is also served as a temporary data storage for captured baseband signals from the baseband circuit 204A or RF BIST results from the test analyzer 208A. The test analyzer 208A can be used to measure power at frequency associated with wanted tone, image tone or second-order or third-order harmonics to test transmitter/receiver gain, image rejection ratio (IRR), input second intercept point (IIP2), input third intercept point (IIP3), etc. In test analyzer 208A, we can implement a noise power estimator to calculate noise power or signal-to-noise ratio (SNR) of receiver for NF test. The lock time measure can also be implemented by software or hardware in the test analyzer 208A to test the lock time of a phase-locked loop (PLL) which comprises the instantaneous frequency estimation, lock time calculation using the information of the frequency estimates, and pass/fail decision. Some estimators of modulated tests such as error vector magnitude (EVM) and spectrum estimators can also be implemented in the test analyzer 208A to evaluate the quality of RF transmitter in RF circuit 206A.

The transmitter path is usually tested at the system level test by the EVM and spectrum, nonlinearity tests such as IIP2 and IIP3, an image signal test, a carrier leakage test, and a transmission power test. The evaluated characteristics for the receiver path comprise a receiver gain test, an image signal test, a DC offset test, NF test, and nonlinearity test such as IIP2 and IIP3.

The RF circuit 206A comprises building circuit elements for an RF transmitter and an RF receiver, including a DAC, an ADC, a filter, a modulator, a demodulator, a local oscillator, a PA, and an LNA. The BIST may be applied to test a single element or a circuit in the RF circuit 206A or whole transmission or reception path. The test analyzer 208A receives the evaluation signals from either the testing module board 24 or the RF circuit 206A to determine a test result signal S_{dout} indicative of whether the DUT has passed or failed the test, and then reports the test result signal S_{dout} to the ATE 22. The command signal S_{cmd} and the test result signal S_{dout} are baseband signals that are at a frequency substantially close to zero, and may be in digital or analog form.

In some implementations, the IC 20 can further comprise a compensator (not shown) to compensate or adjust parameters for the RF circuit elements 206A using digital or analog circuit based on evaluated characteristics of the captured digital signal in test analyzer. In comparison to the conventional RF approach, the present embodiment depicts an RF BIST system where the ATE 22 is only used to initiate the test and keep the test results. The RF BIST tasks including test pattern generation, signal analysis, and test result justification are now shifted to either the IC 20 or the testing module board 24. Consequently, circuit complexity of the ATE 22 can be reduced, thereby decreasing design and manufacturing cost of the ATE 22. Further, the testing module board 24 is included in the test to assist evaluation of the signal characteristics for the signature response, or loop back the transmitter response to the RF receiver. Thus, there are a high-speed communication S_{RF} between the IC 20 and testing module board 24.

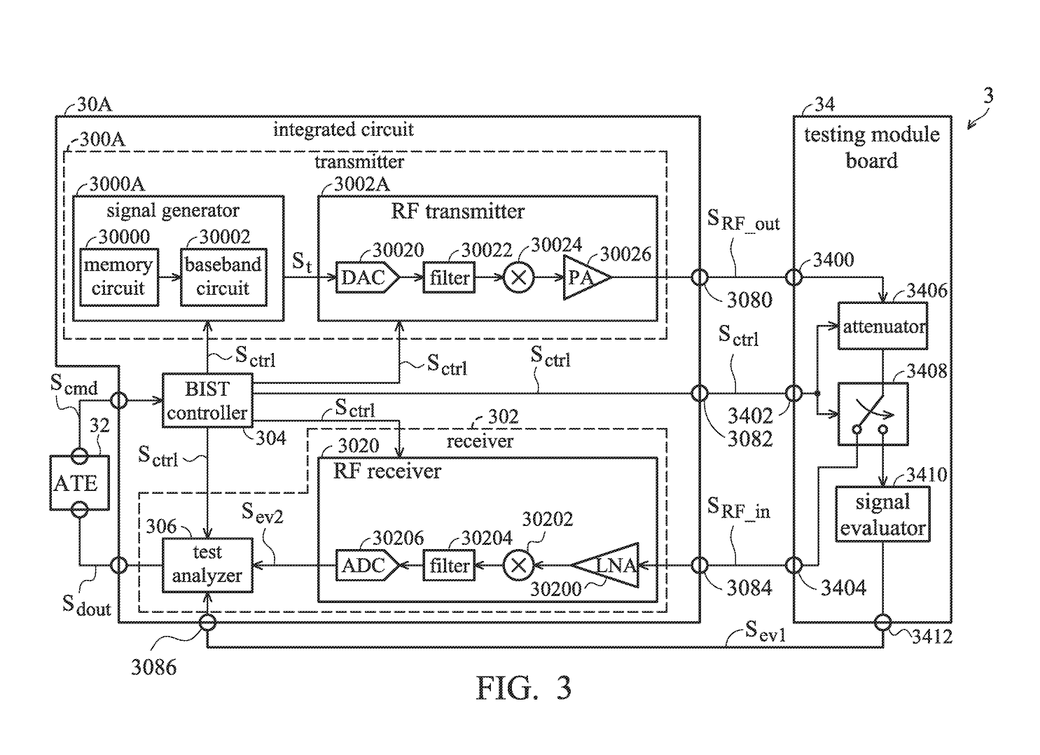

FIG. 3 shows a block diagram of an RF BIST system 3 according to an embodiment of the invention, comprising an IC 30, an ATE 32, and a testing module board 34. The ATE 32 carries out an RF BIST by initiating a baseband command signal S_{cmd} to the IC 30A. In response, the IC 30A enters a test mode and generates a test pattern signal Sₜ internally. The test pattern Sₜ is sent to a RF transmitter 3002A to undergo various analog circuit passing in the transmitter path, rendering an outgoing RF signal S_{RF}_{_}ₒᵤₜ, which is further sent to the testing module board 34 to perform signal analysis. The testing module board 34 exhibits two configurations in the embodiment, one configuration performs signal analysis on the outgoing RF signal S_{RF}_{_}ₒᵤₜ to produce a first evaluation signal Sₑᵥ₁, and the other configuration loops the outgoing RF signal S_{RF}_{_}ₒᵤₜ back to a receiver 302 in the IC 30A. Since the outgoing signal S_{RF}_{_}ₒᵤₜ is RF signal passing analog circuits in the transmitter path, it bears information on the circuit elements. In the signal analysis configuration, the testing module board 34 can evaluate electrical characteristics of the target circuit element based on the outgoing RF signal S_{RF}_{_}ₒᵤₜ to output a first baseband evaluation signal Sₑᵥ₁, which is further reported back to the IC 30A. Based on the first evaluation signal Sₑᵥ₁, the IC 30A then determines and reports a test result signal S_{dout} back to the ATE 32, informing the ATE 32 whether the DUT has passed or failed the test. In the loopback configuration, the outgoing RF signal S_{RF}_{_}ₒᵤₜ is transferred to the receiver 302 to undergo RF impairments in a receiver path, outputting a second baseband evaluation signal Sₑᵥ₂ to the test result analyzer 306. The second baseband evaluation signal Sₑᵥ₂ can be used by the test result analyzer 306 to determine electrical characteristics and functional validity of a receiver circuit element on the receiver path. The command signal S_{cmd} and the test result signal S_{dout} are baseband signals that are at a frequency substantially close to zero, and may be in digital or analog form.

The IC 30A comprises a transmitter 300A, a receiver 302, and a BIST controller 304. The transmitter 300A and the receiver 302 may belong to the same or different transceiver systems. For examples, the transmitter 300A and the receiver 302 may both belong to a WLAN system, or may belong to a WLAN system and a Bluetooth system respectively. The transmitter 300A further comprises a signal generator 3000A and a RF transmitter 3002A. In some implementations, the signal generator 3000A comprises a memory 30000 that keeps various test patterns for BISTs therein and a baseband circuit 30002 that performs digital power control (not shown) and/or digital compensations (not shown) such as in-phase/quadrature (IQ) mismatch and digital pre-distortion. The RF transmitter 3002A comprises a DAC 30020, a filter 30022, a modulator 30024, and a PA 30026. Similarly, the RF receiver 3020 comprises an LNA 30200, a demodulator 30202, a filter 30204, and an ADC 30206. The modulator 30024 and demodulator 30202 may further receive carrier signals from one or more local oscillators (not shown) to modulate and demodulate the outgoing and incoming RF signals respectively. Upon receiving the command signal S_{cmd}, the BIST controller 304 enables relevant circuit elements in IC 30 including the signal generator 3000A, the RF transmitter 3002A, the test result analyzer 306, and the RF receiver 302 to enter into the test mode and control the external circuit components in testing module board 34 including adjustable attenuator and switch. In some implementations, a digital filter is present between the ADC 30206 and the test result analyzer 306. In some implementations, the BIST controller 304 also controls the testing module board 32 to operate under the test mode. The test signal generator 3000A is arranged to generate the test signal Sₜ in response to the command signal S_{cmd}. After test signal Sₜ is fed into the RF transmitter 3002A, the RF transmitter 3002A is arranged to generate the response signal S_{RF}_{_}ₒᵤₜ. The test result analyzer 306 may be implemented by a digital signal processing (DSP) unit or hardware circuits, and arranged to determine and report the test result signal S_{dout} to the ATE 32. The test result signal S_{dout} is determined based on the first evaluation signal Sₑᵥ₁ and processed results of the second evaluation signal Sₑᵥ₂. Specifically, in some implementations, the test result signal S_{dout} is determined based on a first evaluation signal Sₑᵥ₁ derived from the RF signal S_{RF}_{_}ₒᵤₜ. In other implementations, the test result signal S_{dout} is determined based on the second evaluation signal Sₑᵥ₂ which is derived by feeding back the response signal S_{RF}_{_}ₒᵤₜ to the RF receiver 3020.

The IC 30A comprises a first communication port 3080, a second communication port 3082, a third communication port 3084, and a fourth communication port 3412 for communication with the testing module board 34. The first communication port 3080 outputs the outgoing RF signal S_{RF}_{_}ₒᵤₜ to the testing module board 34 and the third communication port 3084 acquires the incoming RF signal S_{RF}_{_}ᵢₙ from the testing module board 34. In addition, the two ports 3080 and 3084 need enough isolation for self-test. Consequently the two ports 3080 and 3084 cannot be implemented by a common communication port on the IC 30. The IC 30A directs the control signal S_{ctrl} through the second communication port 3082 to control the testing module board 34. The fourth communication port 3086 receives the results of signal evaluator 3410 from the testing module board 34.

The testing module board 34 is external to the IC 30A and ATE 32, and comprises an input port 3400, a control port 3402, a loopback port 3404, an adjustable attenuator 3406, a switch 3408, and a signal evaluator 3410 which can be implemented by a power detector, and an output port 3412. In some implementations, a testing load board (not shown) is provided to hold the testing module board 34 and the IC 30A together. The testing load board may comprise an IC socket (not shown) to accept the IC 30A and a module slot (not shown) to hold the testing module board 34 in place during the test. The input port 3400 accepts the response RF signal S_{RF}_{_}ₒᵤₜ from the IC 30A. The control port 3402 receives the control signal S_{ctrl} from the IC 30A to enable the testing module board 34 work under the test mode. The control signal S_{ctrl} controls the attenuator 3406 and the switch 3408. The attenuator 3406 receives controls by the control signal S_{ctrl} to adjust attenuation level to the RF signal S_{RF}_{_}ₒᵤₜ. The switch 3408 is selected by the control signal S_{ctrl} to switch between the signal analysis configuration and the loopback configuration. In the signal analysis configuration, the transmitter response signal S_{RF}_{_}ₒᵤₜ is transferred to the signal evaluator 3410 to determine a power level or a baseband signal thereof as the first evaluation signal Sₑᵥ₁, which is reported back to the IC 30 through the output port 3412. In the loopback configuration, the transmitter output signal S_{RF}_{_}ₒᵤₜ is looped back through the attenuator 3406 as an input RF signal S_{RF}_{_}ᵢₙ to the RF receiver 3020 for a further test in the receiver path. In the receiver, the input RF signal S_{RF}_{_}ᵢₙ is down-converted into the baseband, which is digitized into digital words that are processed by a baseband circuit or DSP.

Although the testing module board 34 accepts the control signal S_{ctrl} from the IC 30A, it should be appreciated by the people skilled in the art that the testing module board 34 can also receive controls from the ATE 32 or provide the control signal by the testing module board 34 locally without deviating from the principle of the invention.

In comparison to the conventional RF test mechanism, the present embodiment depicts an RF BIST system where the ATE 32 is only used to initiate the test and keep the test results. The other RF BIST tasks include test pattern generation, signal analysis, and test result justification, is controlled by the IC 30A and shifted to either the IC 30A or the testing module board 34, leading to a reduction in circuit complexity of the ATE 22, thereby decreasing design and manufacturing cost. Only low-frequency command signal S_{cmd} and test result signal S_{dout} are exchanged between the IC 30A and the ATE 32.

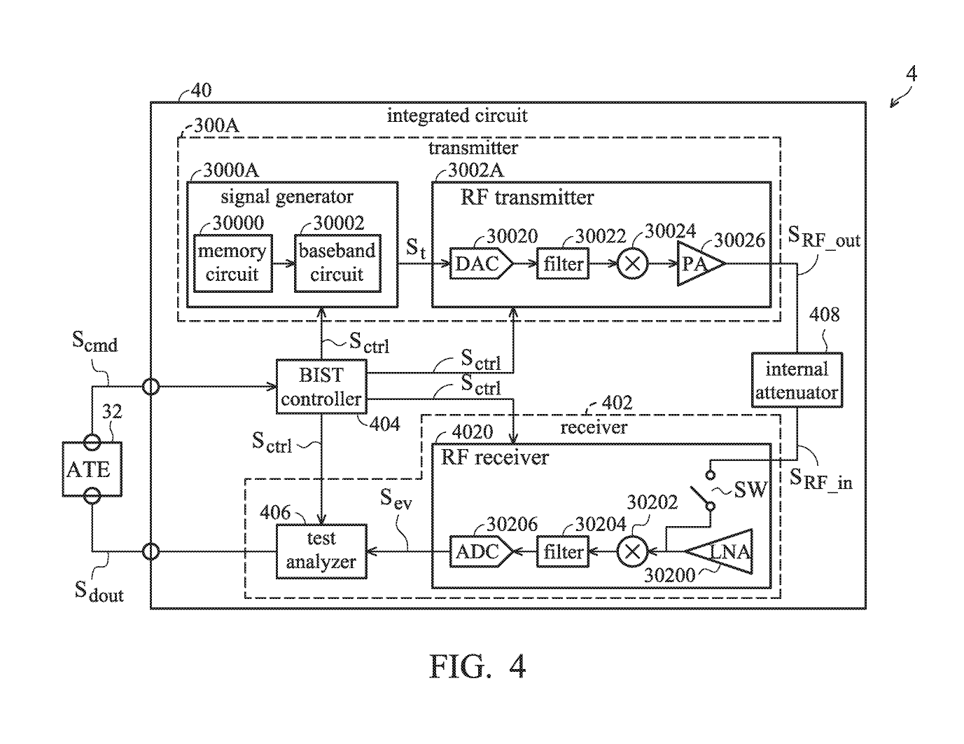

FIG. 4 is a block diagram of an RF BIST system 4 according to another embodiment of the invention, comprising an integrated circuit 40 and the ATE 32. The circuit configuration in FIG. 4 is identical to that in FIG. 3 except that the outgoing RF signal S_{RF}_{_}ₒᵤₜ is looped back through an internal attenuator 408 between the output of the RF transmitter 3002A and the input of RF receiver 4020, such that the signal performance of the RF transmitter 3002A and RF receiver 4020 can be evaluated without uses of the external testing module board 34 in FIG. 3. Upon being triggered by the command signal S_{cmd}, the IC 40 is able to run the RF BIST procedure all by itself to evaluate performance of a selected circuit element or a selected circuit path, and report the RF BIST result back to the ATE 32, without aids from any external circuitry.

The RF BIST is performed at a system level, where the transmitter 300A and receiver 402 belong to a same system. The ATE 32 issues the command signal S_{cmd} to the IC 40 to start the test. In response to the command signal S_{cmd}, the BIST controller 404 is initialed to enable the test mode and control the RF BIST processes. The signal generator 3000A produces the corresponding test pattern Sₜ, which is processed through the RF transmitter 3002A and the input of RF receiver 4020 to render the evaluation signal Sₑᵥ. The different test patterns Sₜ can easily be generated by the implementation of signal generator 3000A in the IC 40 to accommodate different test items. Hence, utilizing the test analyzer 406 the quality of the RF transceiver in IC 40 can be evaluated by processing the signal Sₑᵥ to determine the test result, good or bad, of IC 40 and report the result to the ATE 32. The IC 40 provides the loopback attenuator 408 to loop back the RF signal S_{RF}_{_}ₒᵤₜ from the RF transmitter 3002A to RF receiver 4020, thereby eliminating the uses of the testing module board 34 while still able to carry out the most RF BIST processes in the IC 40. Similar to the RF BIST system 3, the RF BIST system 4 utilizes low-frequency communication between the ATE 32 and IC 40, offering a cost reduction in the ATE 32.

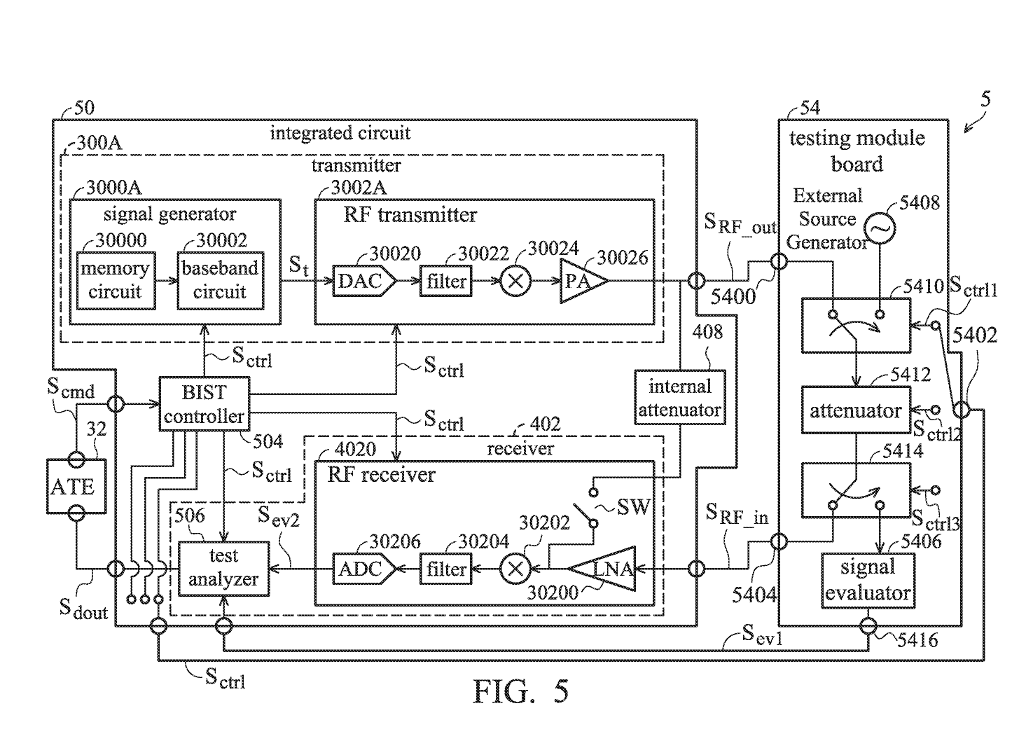

FIG. 5 is a block diagram of an RF BIST system 5 according to yet another embodiment of the invention, comprising an IC 50, an ATE 32, and a testing module board 54. The circuit configuration in FIG. 5 is identical to that in FIG. 4 except that the testing module board 54 is connected to the IC 50. The testing module board 54 is external to the IC 50 and the ATE 32 and comprises circuit elements customized to assist signal analysis of the outgoing RF signal S_{RF}_{_}ₒᵤₜ, thereby determining the first evaluation signal Sₑᵥ₁ indicative of an electrical characteristic of the S_{RF}_{_}ₒᵤₜ. The testing module board 54 receives control externally from either the IC 50 or the ATE 32. The embodiment in FIG. 5 depicts the case where the testing module board 54 receives a control signal S_{ctrl} from the IC 50 to select performing signal analysis on the transmitter path, or looping the RF signal S_{RF}_{_}ₒᵤₜ back to the receiver path, or performing other testing initiated by or measured by the testing module board 54.

The testing module board 54 comprises an input port 5400, a control port 5402, a loopback port 5404, a signal evaluator 5406, an external source generator 5408, a first switch 5410, an attenuator 5412, a second switch 5414, and an output port 5416. The input port 5400 is configured to receive the output RF signal S_{RF}_{_}ₒᵤₜ that carries information of the DUT on the transmitter path. In some embodiments, the input port 5400 and loopback port 5404 of the testing module board 54 are implemented by separated ports while the RF transmitter 3002A and RF receiver 4020 on the IC 50 respectively transmit and receive RF signals by separate ports. In other embodiments, the input port 5400 and the loopback port 5404 can be realized by a common port while the RF transmitter 3002A and RF receiver 4020 on the IC 50 respectively transmit and receive RF signals by another common port. The signal evaluator 5406 is configured to be controlled by an external controller, either by the IC 50 or the ATE 32, to evaluate the outgoing RF signal S_{RF}_{_}ₒᵤₜ to determine a first evaluation signal Sₑᵥ₁ indicating an electrical characteristic of the first test result signal. In turn, the first evaluation signal Sₑᵥ₁ is output to the IC 50 for a test result analysis through the output port 5416. In some implementations, the signal evaluator 5406 is a power detector monitoring power in the outgoing RF signal S_{RF}_{_}ₒᵤₜ. In other implementations, the signal evaluator 5406 is a component which includes one or more analog/digital circuit to convert the RF signal to baseband digital signal and sends the digital signal to IC 50 by output port 5416. The external source generator 5408 is configured to generate an RF test pattern that may be injected into the receiver path as a clear source or reference source in order to evaluate the RF receiver 4020. The first switch 5410 is configured to select one of the output signal S_{RF}_{_}ₒᵤₜ generated by the IC 50 and the second test pattern generated by external source generator 5408 in the testing module board 54. The attenuator 5412 is configured to generate RF source with different signal levels. The second switch 5414 is configured to select one of performing signal analysis on the transmitter path and providing a test pattern to the receiver path. The testing module board 54 receives the control signal S_{ctrl} from the BIST controller 504 to determine a function implemented thereon. In order words, the BIST controller 504 can respectively control at least one of the first switch 5410, the attenuator 5412 and the second switch 5414 by the control signal S_{ctrl} via the control port 5402.

Although the IC 50 incorporates a transmitter path circuitry and a receiver path circuitry, the person in the art will recognize that the RF BIST therefore may be carried out separately according to the principle of the invention. In some implementations, the IC 50 performs a test only on the transmitter path circuitry, so that the testing module board 54 can evaluate the electrical characteristics of the signature response S_{RF}_{_}ₒᵤₜ of the transmitter path to output the evaluation signal Sₑᵥ₁ to the test result analyzer 506. In other implementations, the IC 50 performs a test only on the receiver path circuitry, the testing module board 54 assists to provide the test pattern from source generator 5408 to be injected into the RF receiver 4020 to output the evaluation signal Sₑᵥ₂ to the test result analyzer 506 for receiver tests such as receiver gain, IQ mismatch, DC offset, and nonlinearity, etc.

The RF BIST system 5 provides the customized testing module board 54, capable of evaluating the signal properties for the response signal S_{RF}_{_}ₒᵤₜ of the RF transmitter 3002A and generating a RF test pattern to be injected into the RF receiver 4020, thereby assisting the test signal generation and signal evaluation in the RF BIST processes. Similar to the RF BIST system 3, the RF BIST system 5 utilizes low-frequency communication between the ATE 32 and IC 50, resulting in a cost reduction in the ATE 32.

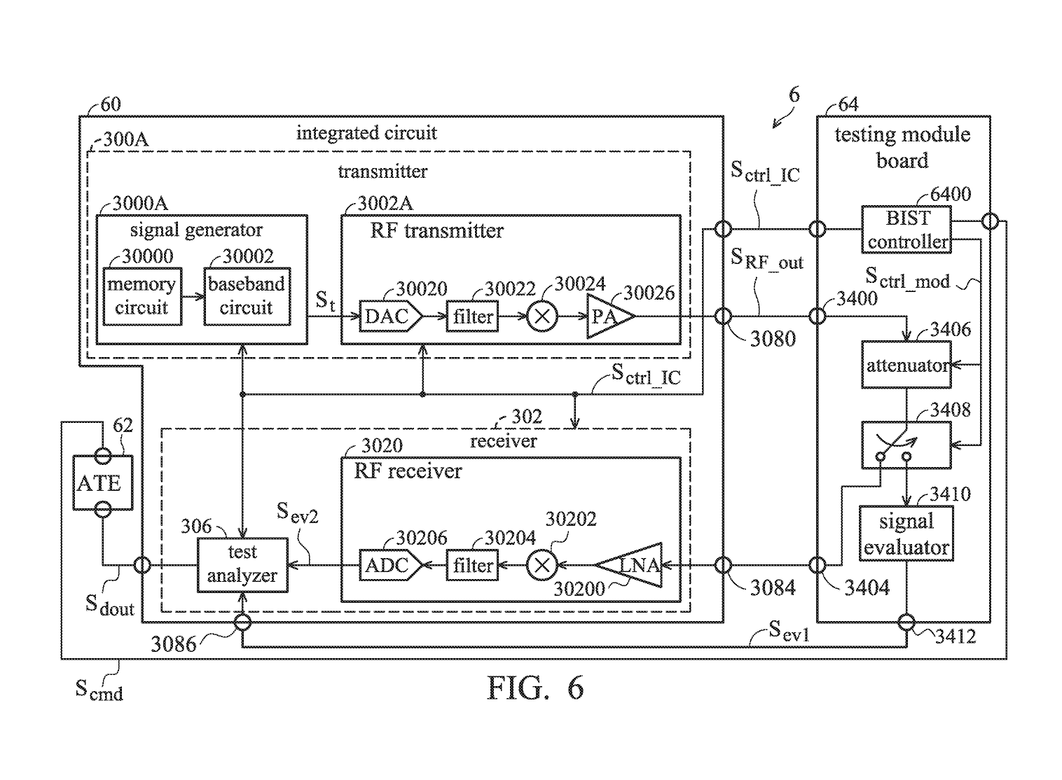

FIG. 6 is a block diagram of an RF BIST system 6 according to still yet another embodiment of the invention, comprising an integrated circuit 60, an ATE 62, and a testing module board 64. The ATE 62 identical to the ATE 22 and ATE 32 in FIG. 2 and FIG. 3, reference therefor is detailed in the preceding paragraphs. The circuit configuration and connection is identical to that in the RF BIST system 3, except that in the RF BIST system 6, a BIST controller 6400 is placed at the testing module board 64, so that the RF test control can be adapted and managed externally from the IC 60. In the embodiment, the testing module board 64 comprises the BIST controller 6400 which receives a command signal S_{cmd} from the ATE 62 for initiating an RF BIST. Instead of controlling the RF BIST procedure from the IC, the BIST controller 6400 oversees all RF BIST operations occurring in the IC 60 by an IC control signal S_{ctrl}_{_}_{IC}, and controls RF BIST operations in the testing module board by a module control signal S_{ctrl}_{_}_{mod}. Upon receiving the command signal S_{cmd}, through the IC control signal S_{ctrl}_{_}_{IC}, the BIST controller 6400 controls the signal generator 3000A to produce a test pattern Sₜ for a corresponding RF BIST for the transmitter path or the loopback path and enables the test pattern Sₜ to pass through the RF transmitter 3002A and output an RF output signal S_{RF}_{_}ₒᵤₜ to the testing module board 64. The BIST controller 6400 also controls the circuit blocks in the testing module board to perform relevant RF BIST operations. In the embodiment, using the module control signal S_{ctrl}_{_}_{mod}, the BIST controller 6400 enables the attenuator 3406 to change power level of the received RF output signal S_{RF}_{_}ₒᵤₜ, or controls the switch 3408 to switch between the signal evaluator 3410 for performing power detection test and/or the loopback path to the IC 60 for performing the BIST for the receiver path of the receiver 302. The BIST controller 6400 may further control the test analyzer 306 in the IC 60 via the IC control signal S_{ctrl}_{_}_{IC} to perform test analysis on RF BIST using the first evaluation signal Sₑᵥ₁ from the testing module board 64, or using the second evaluation signal Sₑᵥ₂ from the receiver 302. Followed by the test analysis, the test analyzer 306 may direct the test result S_{dout} back to the ATE 62 and proceed for the next test.

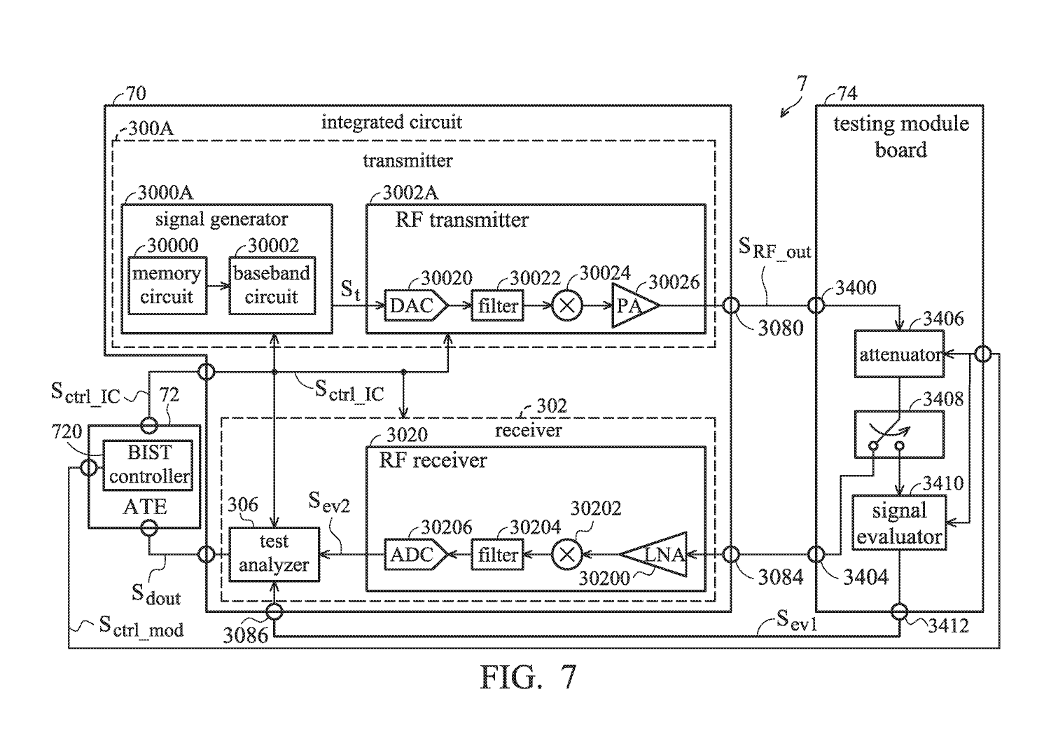

FIG. 7 is a block diagram of an RF BIST system 7 according to yet another embodiment of the invention, comprising an integrated circuit 70, an ATE 72, and a testing module board 74. The testing module board 74 identical to the testing module board 34 FIG. 3, reference therefor is detailed in the preceding paragraphs. The circuit configuration and connection is identical to that in the RF BIST system 3, except that in the RF BIST system 7, a BIST controller 720 is provided at the ATE 72. In the embodiment, the IC 70 and the testing module board 74 receive test controls from the ATE 72, thus no command signal S_{cmd} is required to initiate an RF BIST. The BIST controller 720 manages all RF BIST operations in the IC 70 by an IC control signal S_{ctrl}_{_}_{IC}, and controls all RF BIST operations in the testing module board 74 by a module control signal S_{ctrl}_{_}_{mod}. Through the IC control signal S_{ctrl}_{_}_{IC}, the BIST controller 720 controls the signal generator 3000A to produce a test pattern Sₜ for a corresponding RF BIST for the transmitter path or the loopback path and enables the test pattern Sₜ to pass through the RF transmitter 3002A and output an RF output signal S_{RF}_{_}ₒᵤₜ to the testing module board 74. Through the module control signal S_{ctrl}_{_}_{mod}, the BIST controller 720 controls the attenuator 3406 to change power level of the received RF output signal S_{RF}_{_}ₒᵤₜ, or controls the switch 3408 to switch between the signal evaluator 3410 for performing power detection test and/or the loopback path to the IC 70 for performing the BIST for the receiver path of the receiver 302. The BIST controller 720 may further control the test analyzer 306 in the IC 70 via the IC control signal S_{ctrl}_{_}_{IC} to perform test analysis on RF BIST using the first evaluation signal Sₑᵥ₁ from the testing module board 74, or the second evaluation signal Sₑᵥ₂ from the receiver 302. Followed by the test analysis, the test analyzer 306 may report the test result S_{dout} back to the ATE 62 and proceed for the next test.

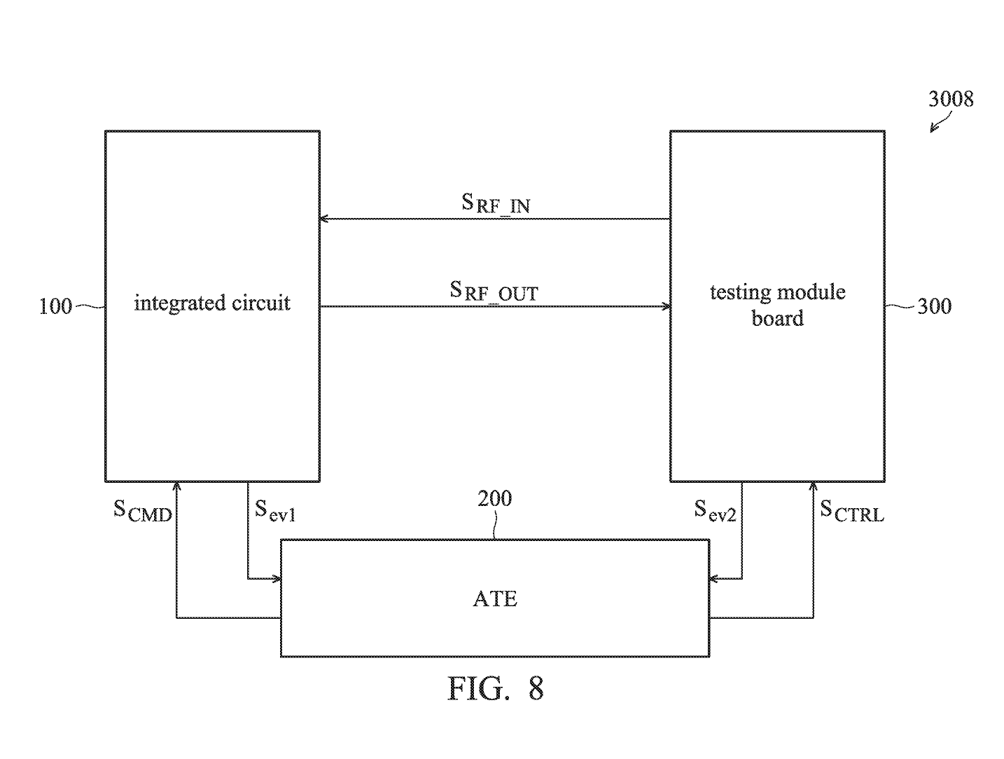

FIG. 8 is a simplified schematic block diagram of an RF testing system 3008 according to an embodiment of the invention. As illustrated in FIG. 8, the RF testing system 3008 may comprise an IC 100, ATE 200, and a testing module board (e.g. a module circuitry) 300. The ATE 200 initializes a test process by sending a command signal S_{CMD} to the IC 100. In response, the IC 100 is arranged to enter into a test mode, and, in contrast to the ATE 200 controlling the test process in the conventional approach, the IC 100 takes control of the test operations. However, this is for illustrative purpose rather than a limitation of the present invention. In other embodiments (which will be illustrated later), the test process control may take place in the testing module board 300, where the ATE 200 send the command signal S_{CMD} to the testing module board 300, and the testing module board 300 then sends a control signal to the IC 100 accordingly. Or, the ATE 200 may be equipped with the test process controlling. Moreover, the test process aims to locate defective build elements in mixed-mode circuitry or analog circuitry in the IC 100. Under the test mode, the IC 100 communicates with the testing module board 300 using RF signals or analog signals. For example, the IC 100 may transmit the RF signals S_{RF}_{_}_{OUT} to the testing module board 300 for transmission-performance evaluation or receive RF signals S_{RF}_{_}_{IN} from the testing module board 300, which is generated by the testing module board 300 itself or the IC 100 itself and passing through the testing module board 300 using an external loopback path, to evaluate the reception performance of the IC 100 (details will be described later). The output signals Sₑᵥ₁ may be an evaluation signal which is low-frequency (e.g., baseband, close to zero) produced and sent by the IC 100 to the ATE 200 for a test analysis. Similarly, the output signals Sₑᵥ₂ may be an evaluation signal which is low-frequency (e.g., baseband, close to zero) produced and sent by the testing module board 300 to the ATE 200 for a test analysis. The testing module board 300, which is external to the IC 100 and ATE 200, comprises discrete components to assist signal property analysis as well as RF testing signal generation and receive a control signal S_{CTRL} from the ATE 200 in the test mode. In this way, the ATE 200 does not need to process high-frequency (e.g. radio frequency) signals, and therefore the cost can be reduced. As the test analysis is performed by the ATE 200, the DUT is not necessarily equipped with a digital signal processor, that is, the IC 100 can be a system-on-chip (SOC) circuit or a stand-alone RF IC. In the following sections, different test configurations will be described.

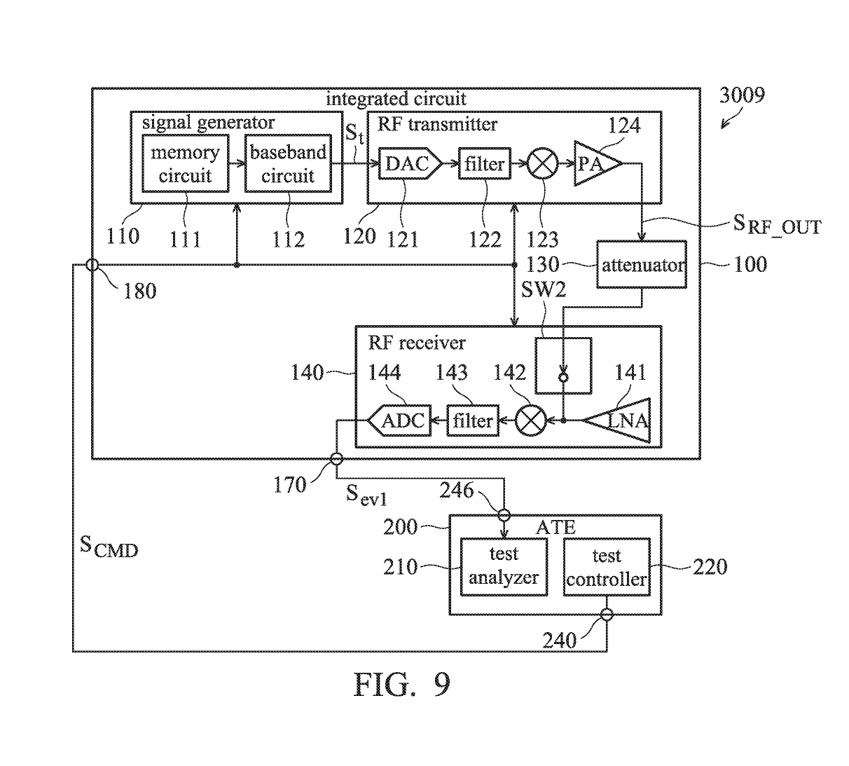

FIG. 9 is a detailed schematic block diagram of the RF testing system 3009 according to an embodiment of the invention. The RF testing system 3009 may comprise an IC 100 and ATE 200. For example, the IC 100 may be a system-on-chip (SOC) or a stand-alone RF IC having digital-to-analog converters (DAC) and analog-to-digital converters (ADC). As illustrated in FIG. 9, the IC 100 comprises a signal generator 110, an RF transmitter 120, an attenuator 130, an RF receiver 140, and communication ports 170, 180. The RF transmitter 120 and the RF receiver 140 may belong to the same or different transceiver systems. For examples, the transmitter 120 and the receiver 140 may both belong to a WLAN system, or they may respectively belong to a WLAN system and a Bluetooth system. In some implementations, the signal generator 110 comprises a memory circuit 111 that keeps various test patterns for the RF test process therein, and a baseband circuit 112 that performs digital power control (not shown) and/or digital compensations (not shown) such as in-phase/quadrature (IQ) mismatch and digital pre-distortion. The RF transmitter 120 comprises a DAC 121, a filter circuit 122, a modulator 123, and a power amplifier (PA) 124. Similarly, the RF receiver 140 comprises a demodulator 142, a filter 143, and an ADC 144. The modulator 123 and demodulator 142 may further receive carrier signals from one or more local oscillators (not shown) to modulate and demodulate the outgoing and incoming RF signals, respectively. In this internal loopback configuration, the communication port 170 outputs an evaluation signal Sₑᵥ₁ generated by the RF receiver 140 to the ATE 200.

As illustrated in FIG. 9, the ATE 200 may comprise a test analyzer 210, a test controller 220, and communication ports 240, 246. The test controller 220 of the ATE 200 directs the command signal S_{CMD} through the communication ports 240 and 180 to components of the IC 100, thereby controlling components of the IC 100 to perform the RF test process. In response, the IC 100 enters a test mode and generates a test pattern signal Sₜ internally. The test pattern Sₜ is sent to the RF transmitter 120 to undergo various analog circuits passing in the transmitter path, rendering an outgoing RF signal S_{RF}_{_}_{OUT}, which is further sent to the RF receiver 140 through the internal attenuator 130. The test analyzer 210 can be used to measure power at frequency associated with wanted tone, image tone or second-order or third-order harmonics to test transmitter/receiver gain, image rejection ratio (IRR), input second intercept point (IIP2), input third intercept point (IIP3), etc. In the test analyzer 210, we can implement a noise-power estimator to calculate noise power or signal-to-noise ratio (SNR) of the receiver for the NF test. The lock-time measure can also be implemented by software or hardware in the test analyzer 210 to test the lock time of a phase-locked loop (PLL), which comprises the instantaneous frequency estimation, lock-time calculation using the information of the frequency estimates, and pass/fail decision. Some estimators of modulated tests such as error vector magnitude (EVM) and spectrum estimators can also be implemented in the test analyzer 210 to evaluate the quality of the RF transmitter 120.

Specifically, in the internal loopback configuration, the outgoing RF signal S_{RF}_{_}_{OUT} is transferred to the demodulator 142 of the RF receiver 140 through the attenuator 130 to undergo RF impairments in a receiver path, outputting a first baseband evaluation signal Sₑᵥ₁ through the communication port 170 to the test analyzer 210 of the ATE 200 for test analysis.

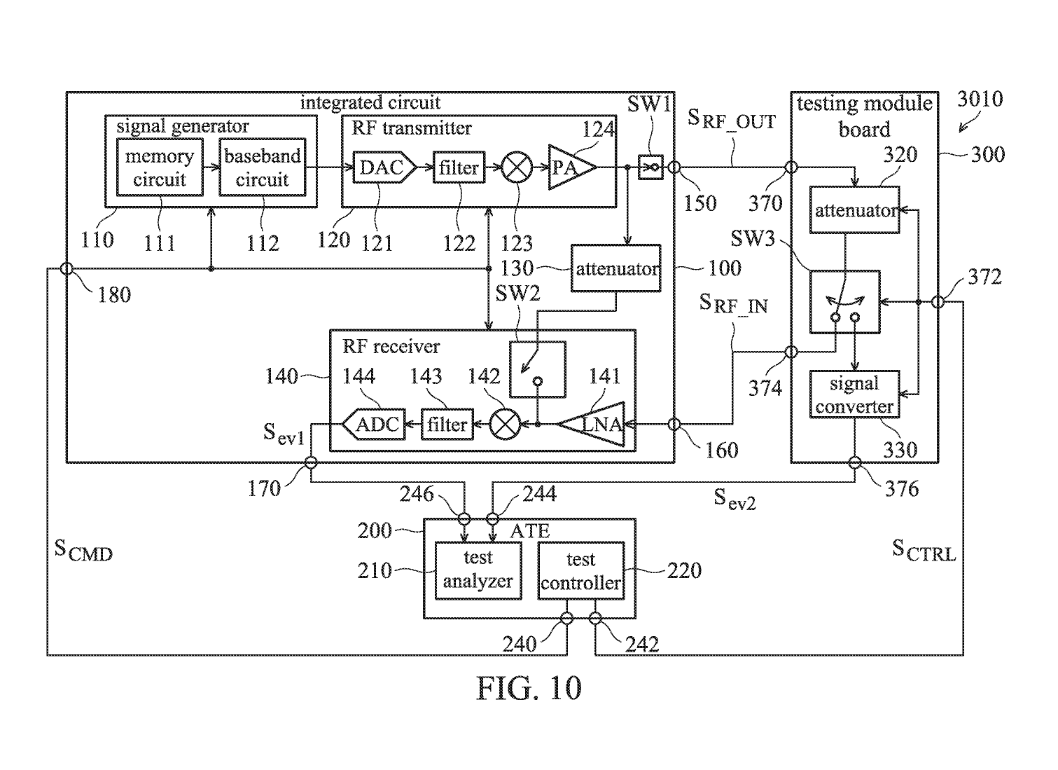

FIG. 10 is a detailed schematic block diagram of the RF testing system 3010 according to another embodiment of the invention. The circuit configuration is similar to that in FIG. 9 except that the testing module board 300 is connected to the IC 100 and a low noise amplifier (LNA) 141 and switches SW1, SW2 are involved. The input of the demodulator 142 can be from the internal attenuator 130 or from the LNA 141 when the internal loopback path or the external loopback path is selected, respectively (details will be described later). When the internal loop-back path is selected (corresponding to FIG. 3), the switch SW1 is opened and the switch SW2 is closed, so that the outgoing RF signal S_{RF}_{_}_{OUT} is looped back through the internal attenuator 130 between the output of the RF transmitter 120 and the input of the RF receiver 140, such that the signal performance of the RF transmitter 120 and RF receiver 140 can be evaluated without the use of the external testing module board 300. In the embodiment of FIG. 10, the external loopback configuration is selected. In response, the switch SW1 is closed and the switch SW2 is opened. In addition, the test controller 220 of the ATE 200 further directs the control signal S_{CTRL} through the communication ports 242, 372 to control the testing module board 300, and the communication port 160 of the IC 100 acquires the incoming RF signal S_{RF}_{_}_{IN} from the testing module board 300.

As illustrated in FIG. 10, the testing module board 300, which is external to the IC 100 and the ATE 200, may comprise an input port 370, a loopback port 374, a control port 372, an output port 376, an adjustable attenuator 320, a switch SW3, and a signal converter 330. In some implementations, a testing load board (not shown) is provided to hold the testing module board 300 and the IC 100 together. The testing load board may comprise an IC socket (not shown) to accept the IC 100 and a module slot (not shown) to hold the testing module board 300 in place during the test. The input port 370 accepts the response RF signal S_{RF}_{_}_{OUT} from the IC 100. The control port 372 receives the control signal S_{CTRL} from the test controller 220 of the ATE 200 to enable the testing module board 300 to work under the test mode. The control signal S_{CTRL} controls the attenuator 320 and switching of the switch SW3. Specifically, the attenuator 320 receives controls via the control signal S_{CTRL} to adjust the attenuation level to the RF signal S_{RF}_{_}_{OUT}. The switch SW3 is selected by the control signal S_{CTRL} to switch between the signal converter configuration (i.e. through the signal converter 330) and the external loopback configuration (i.e. through the loopback port 374). In the external loopback configuration, the switch SW3 is switched to the loopback port 374, the outgoing RF signal S_{RF}_{_}_{OUT} from the RF transmitter 120 is attenuated by the attenuator 320 of the testing module board 300, and then output to the LNA 141 of the RF receiver 140 through the loopback port 374 to undergo RF impairments in a receiver path. In other words, the RF transmitter output signal S_{RF}_{_}_{OUT} is looped back through the attenuator 320 as an input RF signal S_{RF}_{_}_{IN} to the RF receiver 140 for a further test in the receiver path. In the RF receiver 140, the input RF signal S_{RF}_{_}_{IN} is down-converted into the baseband, which is digitized into digital words regarded as the evaluation signal Sₑᵥ₁ sent to the test analyzer 210 of the ATE 200 for test analysis.

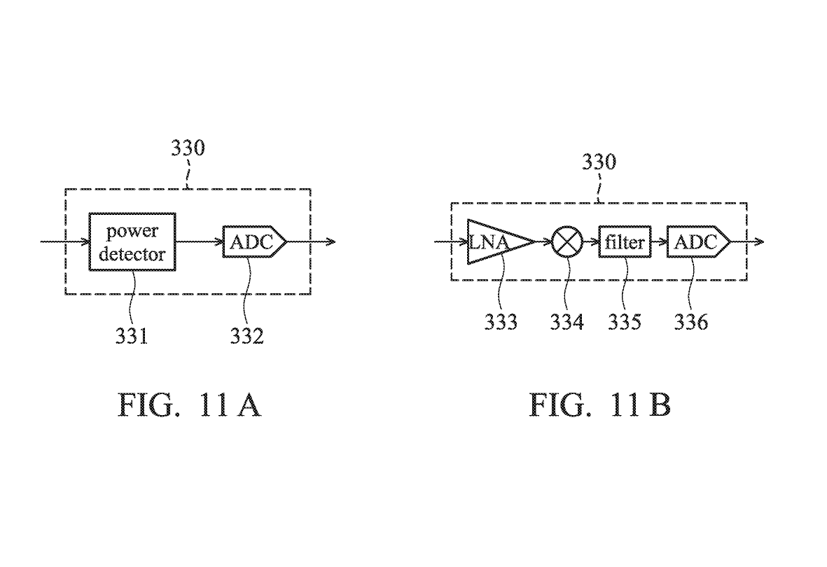

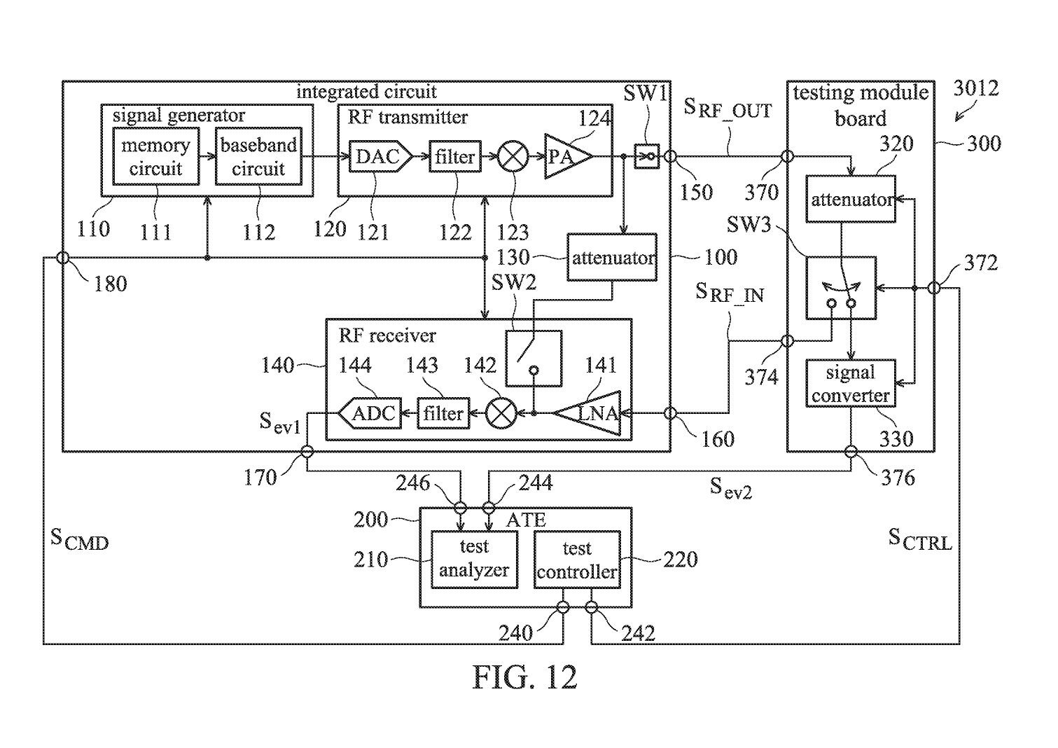

In the signal converter configuration, as shown in FIG. 12, the switch SW3 is switched to the signal converter 330, the outgoing RF signal S_{RF}_{_}_{OUT} from the RF transmitter 120 is attenuated by the attenuator 320 of the testing module board 300, and then converted by the signal converter 330. In other words, the RF transmitter output signal S_{RF}_{_}_{OUT} is not looped back to the IC 100, but processed by the testing module board 300 to generate the evaluation signal Sₑᵥ₂ sent to the test analyzer 210 of the ATE 200 through ports 374 and 244 for test analysis. FIGS. 11A-11B are schematic block diagrams of the signal converter 330 according to different embodiments of the invention. The signal converter 330 may be implemented in different circuits, thereby converting RF signals into analog/digital signals. For example, the signal converter 330 may comprise a power detector 331 and an ADC 332, as illustrated in FIG. 11A. Alternatively, the signal converter 330 may have similar components, such as an LNA 333, a demodulator 334, a filter 335, and an ADC 336, as those in the RF receiver 140, as illustrated in FIG. 11B. It should be noted that the invention is not limited to the aforementioned implementations of the signal converter 330. For those skilled in the art, it is appreciated that a reference RF receiver can be implemented in various circuits, and the details will not be described here.

It should be noted that the evaluation signals Sₑᵥ₁ and Sₑᵥ₂ may be in analog or digital form. In some implementations, the RF transmitter 120 and the RF receiver 140 do not have DAC/ADC circuits, and the test analyzer 210 may further comprise a digitizer (not shown) to convert the incoming analog evaluation signals into digital signals, thereby performing digital signal analysis of the RF test process.

In comparison to conventional RF test mechanisms, the present embodiment depicts an RF testing system where signal received/transmitted by the ATE 200 is only low-frequency signals. Only low-frequency command signal S_{CMD} and evaluation signals Sₑᵥ₁ are exchanged between the IC 100 and the ATE 200. In addition, only low-frequency control signal S_{CTRL} and evaluation signals Sₑᵥ₂ are exchanged between the testing module board 300 and the ATE 200. It should be noted that high-speed communication is only between the IC 100 and the testing module board 300. This leads to a reduction in the circuit complexity of the ATE 200, thereby decreasing design and manufacturing cost.

In view of the above, three configurations, which are the internal loopback configuration, the external loopback configuration, and the signal converter configuration, are provided to test the transmission performance of the IC 100. Upon receiving the evaluation signal Sₑᵥ₁ or Sₑᵥ₂, a test analysis of the transmission performance of the IC 100 can be performed by the test analyzer 210 of the ATE 200. For example, the transmitter path is usually tested at the system level test by the EVM and spectrum, nonlinearity tests such as IIP2 and IIP3, an image signal test, a carrier leakage test, and a transmission power test.

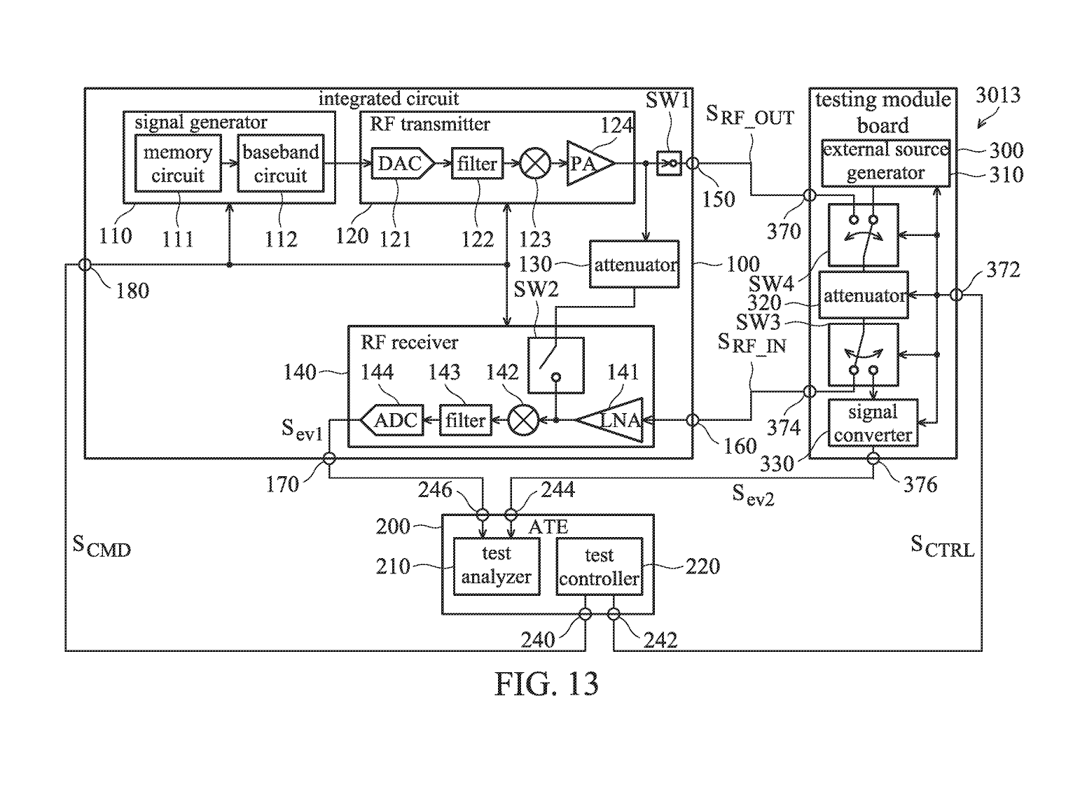

FIG. 13 is a detailed schematic block diagram of the RF testing system 3013 according to still yet another embodiment of the invention. The circuit configuration and connection is similar to those in the RF testing system 3012, except that in the RF testing system 3013, an external source generator 310 and a switch SW4 are placed at the testing module board 300 for further performing Rx test process. The switch SW4 is controlled by the control signal S_{CTRL} to switch between the incoming RF signals from the RF transmitter 120 or from the external source generator 310. Specifically, referring to FIG. 13, upon receiving the control signal S_{CTRL} indicating initiation of an RF Rx test process, the external source generator 310 may start to generate the single-tone, two-tone, and modulation signals required in the RF Rx test process. Meanwhile, the switch SW4 is switched to the external source generator 310 and the switch SW3 is switched to the communication port 374. In response, the generated signals from the external source generator 310 are fed into the attenuator 320, and then the attenuated RF signals are transmitted to the LNA 141 of the RF receiver 140 via the communication port 374, thereby evaluating the reception performance of the IC 100 in the receiver path at the test analyzer 210. Similarly, the RF receiver 140 may output the first evaluation signal Sₑᵥ₁ through the communication port 170 to the test analyzer 210 of the ATE 200 for test analysis. Upon receiving the evaluation signal Sₑᵥ₁, a test analysis of the reception performance of the IC 100 can be performed by the test analyzer 210 of the ATE 200. For example, the evaluated characteristics for the receiver path comprise a receiver gain test, an image signal test, a DC offset test, an NF test, and nonlinearity tests such as IIP2 and IIP3.

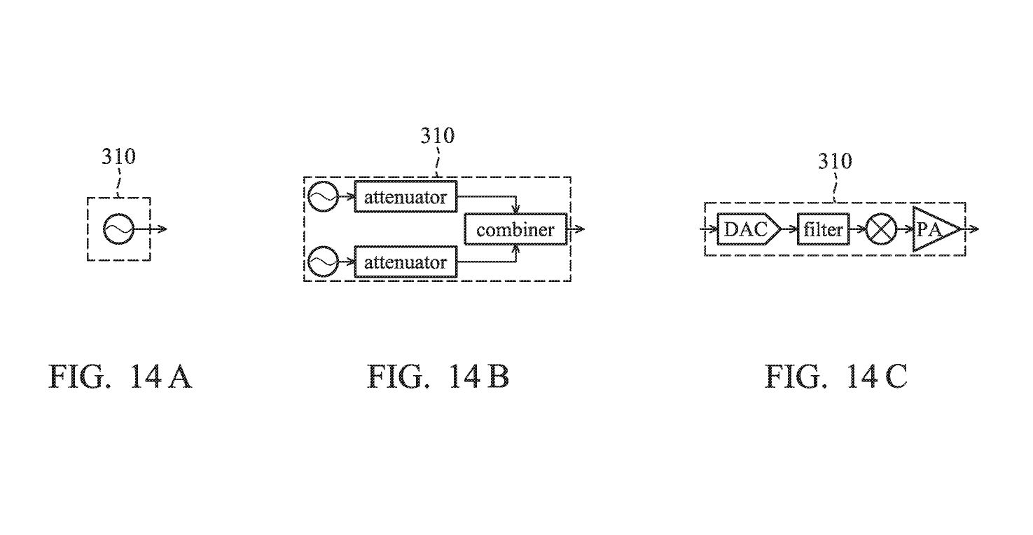

FIG. 14A˜14C are block diagrams of the external source generator 310 according to different embodiments of the invention. For example, the external source generator 310 may be a single-tone generator, a dual-tone generator, and/or a reference RF transmitter, as illustrated in FIGS. 14A, 14B and 14C, respectively. The DAC in FIG. 14C may be coupled to a test pattern generator not shown, or receive test pattern from the TE 200. Implementations of the signal-tone generator, dual-tone generator, and the reference RF transmitter are well-known to those skilled in the art, and the details will not be described here.

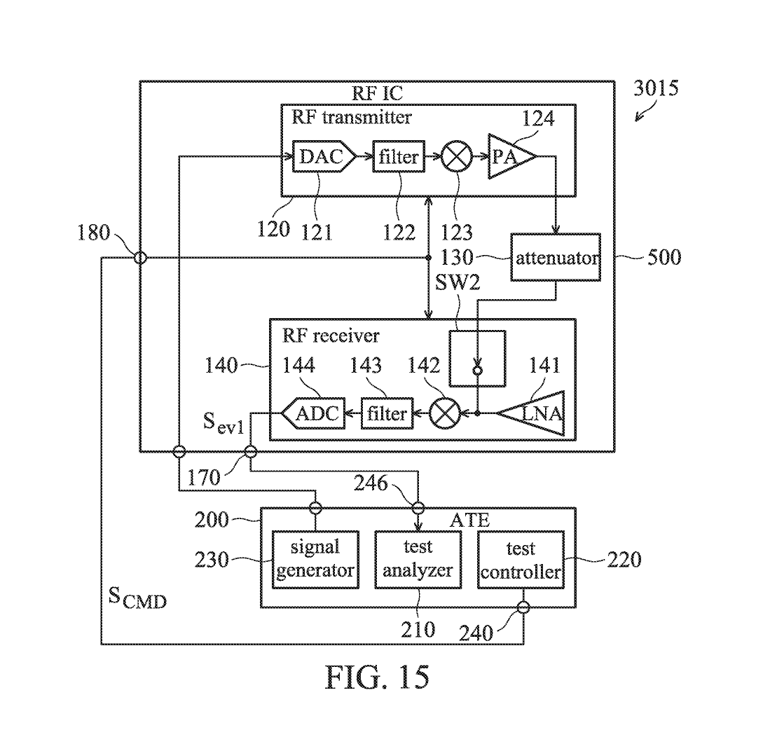

FIG. 15 is a schematic block diagram of an RF testing system 3015 according to an embodiment of the invention. In the RF testing system 3015, the IC 500 may be a stand-alone RF IC without a signal generator. Accordingly, the function of the signal generator is moved to the ATE 200. In other words, the test controller 220 may control the signal generator 230 internally, thereby transmitting predefined RF test patterns to the RF transmitter 120. The circuit configuration and connection of the remaining components in the RF testing system 3015 are similar to those in the RF testing system 3009, and the details can be referred to in the aforementioned embodiments of FIG. 9. Similar to the embodiment of FIG. 9, the internal loopback configuration is also selected in the RF testing system 3015. Specifically, the RF transmitter 120 receives the external RF test pattern signals from the signal generator 230 of the ATE 200. Then, the outgoing RF signal generated by the RF transmitter 120 may be internally fed back to the RF receiver 140 through the internal attenuator 130. In addition, the evaluation signal Sₑᵥ₁ output by the RF receiver 140 can be fed into the test analyzer 210 for test analysis.

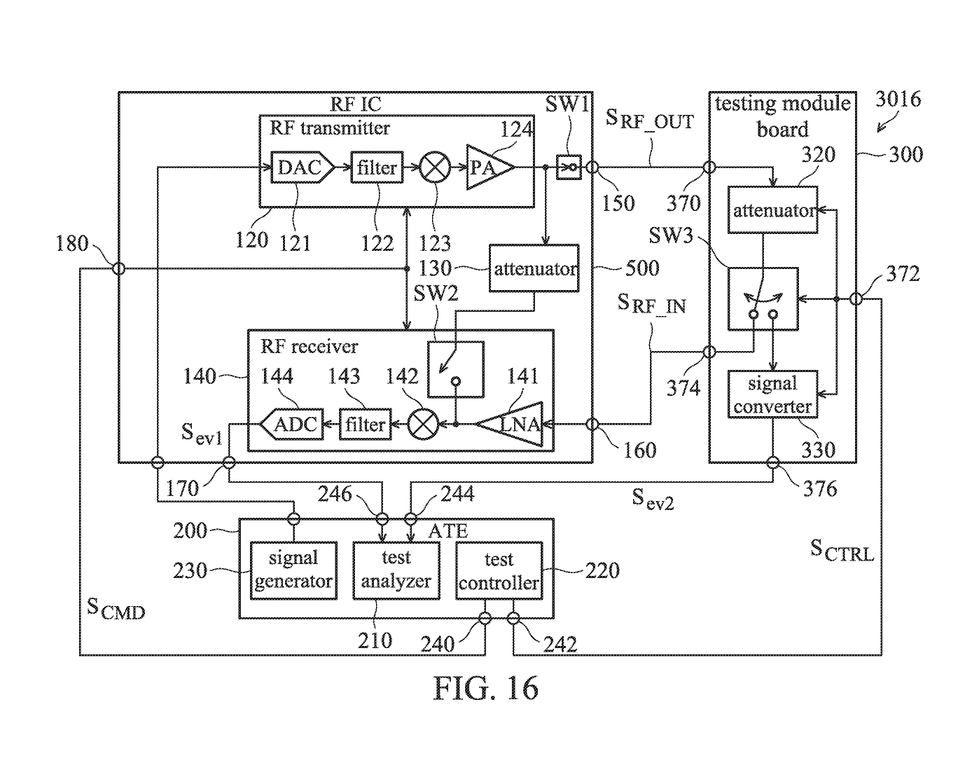

FIG. 16 is a schematic block diagram of an RF testing system 3016 according to another embodiment of the invention. In the RF testing system 3016, the IC 500 may be a stand-alone RF IC without a signal generator. Accordingly, the function of the signal generator is moved to the ATE 200. In other words, the test controller 220 may control the signal generator 230 internally, thereby transmitting predefined RF test patterns to the RF transmitter 120. The circuit configuration and connection of the remaining components in the RF testing system 3016 are similar to those in the RF testing system 3010, and the details can be referred to in the aforementioned embodiments of FIG. 10. Similar to the embodiment of FIG. 10, the external loopback configuration is also selected in the RF testing system 3016. Specifically, the RF transmitter 120 receives the external RF test pattern signals from the signal generator 230 of the ATE 200 and generates the outgoing RF test signal S_{RF}_{_}_{OUT}. Then, the outgoing RF test signal S_{RF}_{_}_{OUT} from the RF transmitter 120 is transmitted to the testing module board 300. The RF test signal S_{RF}_{_}_{OUT} is attenuated by the attenuator 320 in the testing module board 300, and the attenuated RF test signal is further fed back into the RF receiver 140 through the communication port 160. Subsequently, the evaluation signal Sₑᵥ₁ output by the RF receiver 140 can be fed into the test analyzer 210 for test analysis.

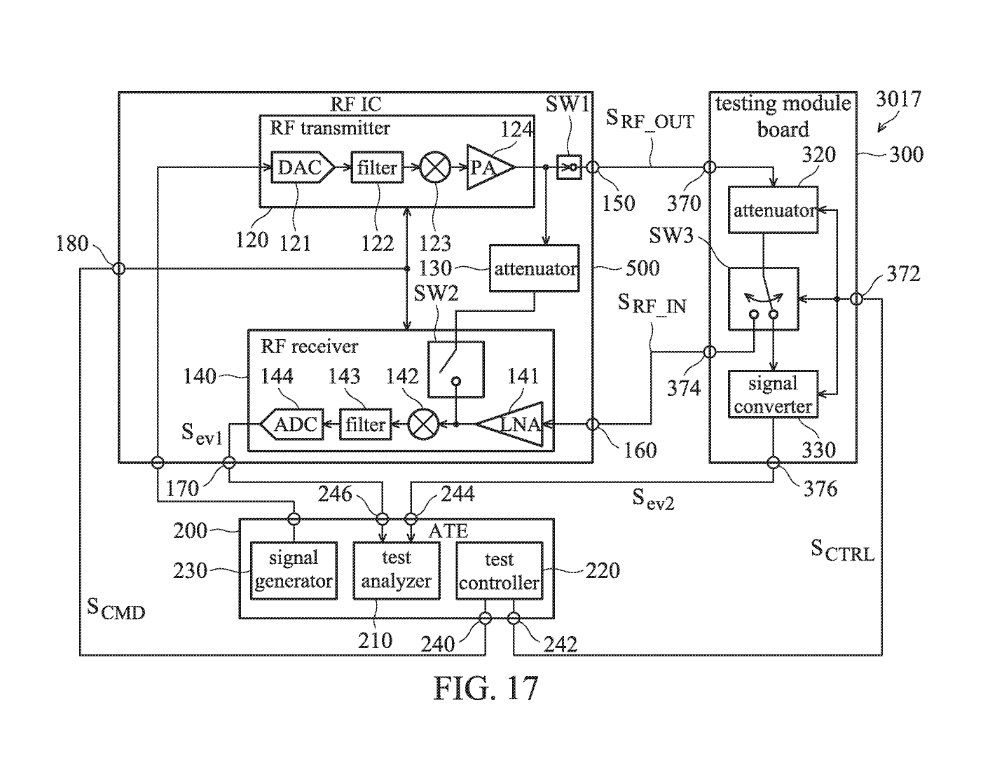

FIG. 17 is a schematic block diagram of an RF testing system 3017 according to yet another embodiment of the invention. In the RF testing system 3017, the IC 500 may be a stand-alone RF IC without a signal generator. Accordingly, the function of the signal generator is moved to the ATE 200. In other words, the test controller 220 may control the signal generator 230 internally, thereby transmitting predefined RF test patterns to the RF transmitter 120. The circuit configuration and connection of the remaining components in the RF testing system 3011 are similar to those in the RF testing system 3012, and the details can be referred to in the aforementioned embodiments of FIG. 12. Similar to the embodiment of FIG. 12, the signal converter configuration is also selected in the RF testing system 3017. Specifically, the RF transmitter 120 receives the external RF test pattern signals from the signal generator 230 of the ATE 200. Then, the outgoing RF test signal S_{RF}_{_}_{OUT} from the RF transmitter 120 is transmitted to the testing module board 300. The RF test signal S_{RF}_{_}_{OUT} is attenuated by the attenuator 320 in the testing module board 300, and the attenuated RF test signal is further fed into the signal converter 330 for signal conversion. Subsequently, a second evaluation signal Sₑᵥ₂ is generated by the signal converter 330, and is further transmitted to the test analyzer 210 of the ATE 200 through the communication port 376.

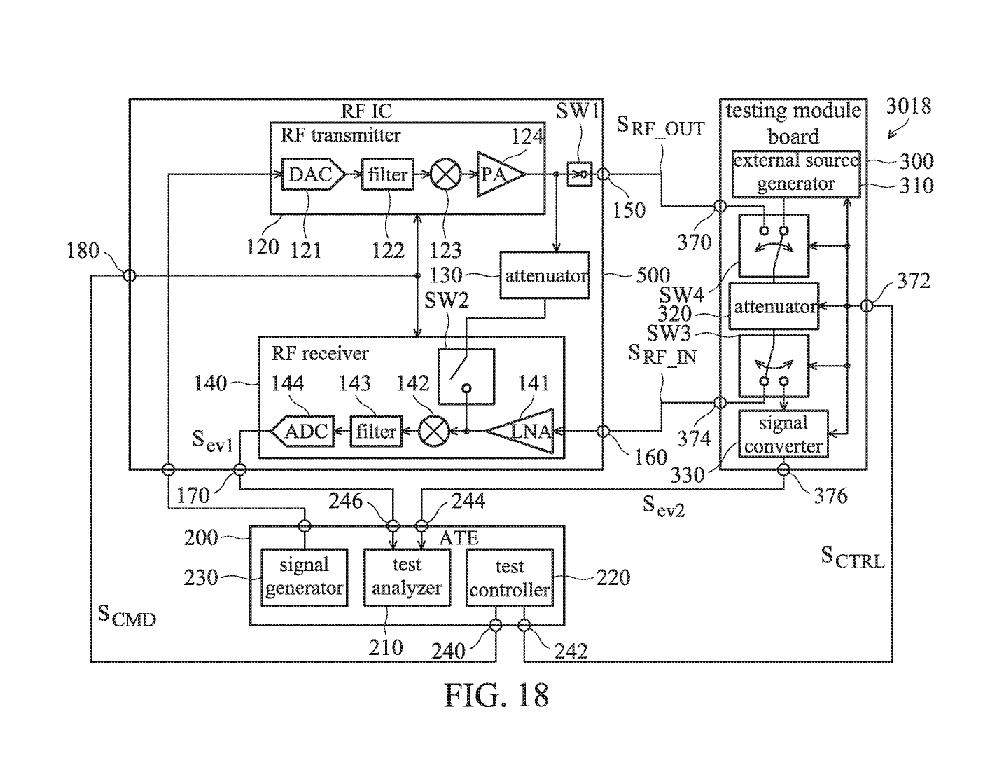

FIG. 18 is a schematic block diagram of an RF testing system 3018 according to still yet another embodiment of the invention. In the RF testing system 3018, the IC 500 may be a stand-alone RF IC without a signal generator. The circuit configuration and connection of the components in the RF testing system 3018 are similar to those in the RF testing system 3013 except that the signal generator 230 has been moved to the ATE 200, and the details can be referred to in the aforementioned embodiments of FIG. 13. Similar to the RF testing system 3013, the testing module board 300 is controlled by the control signals S_{CTRL} generated by the test controller 220 of the ATE 200. Specifically, upon receiving the control signal S_{CTRL} indicating initiation of an RF Rx test process, the external source generator 310 may start to generate the single-tone, two-tone, and modulation signals required in the RF Rx test process. Meanwhile, the switch SW4 is switched to the external source generator 310 and the switch SW3 is switched to the communication port 374, so that the generated signals from the external source generator 310 may be fed into the attenuator 320, and then the attenuated RF signals can be transmitted to the LNA 141 of the RF receiver 140 via the communication port 374, thereby evaluating the reception performance of the IC 100 in the receiver path at the test analyzer 210. Similarly, the RF receiver 140 may output the first evaluation signal Sₑᵥ₁ through the communication port 170 to the test analyzer 210 of the ATE 200 for test analysis. Upon receiving the evaluation signal Sₑᵥ₁, a test analysis of the reception performance of the IC 100 can be performed by the test analyzer 210 of the ATE 200.

It should be noted that the evaluation signals Sₑᵥ₁ and Sₑᵥ₂ may be in analog or digital form. In some implementations, the above-mentioned RF transmitter and RF receiver do not have DAC/ADC circuits, and the test analyzer 210 may further comprise a digitizer (not shown) to convert the incoming analog evaluation signals into digital signals, thereby performing digital signal analysis of the RF test process.

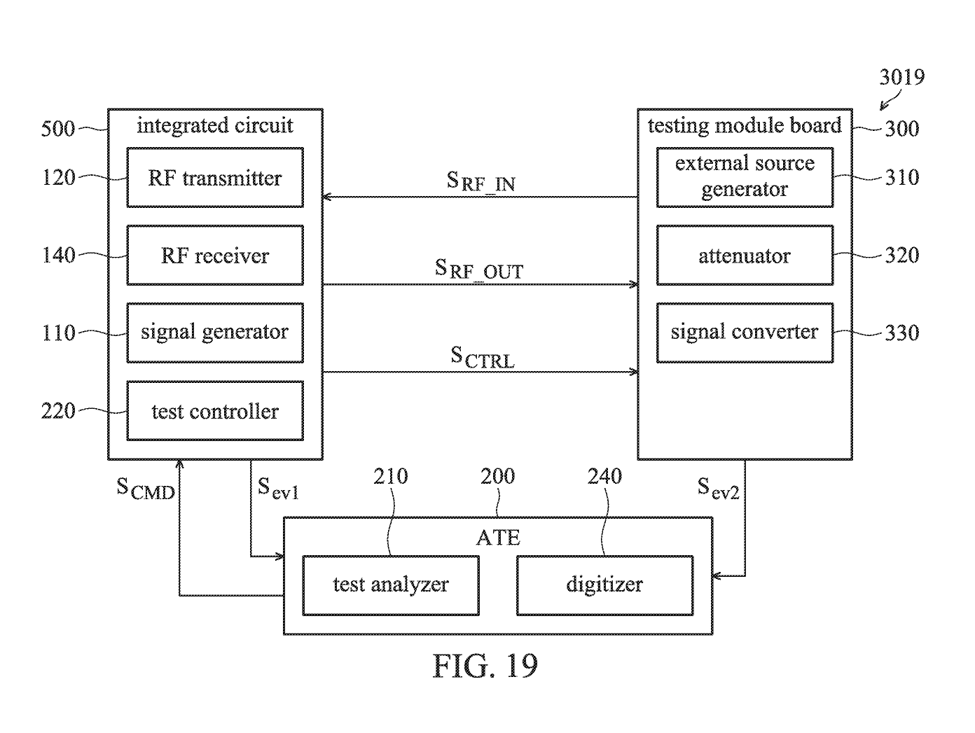

FIG. 19 is a schematic block diagram of an RF testing system 3019 according to still another embodiment of the invention. In the RF testing system 3019, the IC 500 may be a SOC or a stand-alone RF IC having a test controller, and the circuit configuration and connection of the components in the RF testing system 3019 are similar to those in the RF testing system 3013 except that the test controller 220 has been moved to the IC 500. In the embodiment, the test analyzer 210 of the ATE 200 is capable of initiating an RF Tx or Rx test process by issuing a command signal (i.e. a digital signal) S_{CMD} to the test controller 220 in the IC 500, and the test controller 220 in the IC 500 may send corresponding control signals S_{CTRL} to the components in the IC 500 and the testing module board 300 in response to the command signal S_{CMD}. It should be noted that different RF test configurations, which are previously described in the embodiments of FIGS. 9 to 18, can be used in the RF testing system 3019, and the details can be referred to in the embodiment of FIGS. 9 to 18. Specifically, the test analyzer 210 of the ATE 200 is still responsible for receiving the evaluation signal (i.e. a low-speed analog/digital signal) from either the RF receiver 140 or the signal convertor 330 for digital signal analysis. When the evaluation signal from either the RF receiver 140 or the signal convertor 330 is in an analog form, the digitizer 240 of the ATE 200 may convert the evaluation signal into digital signals before the test analysis is performed by the test analyzer 210.

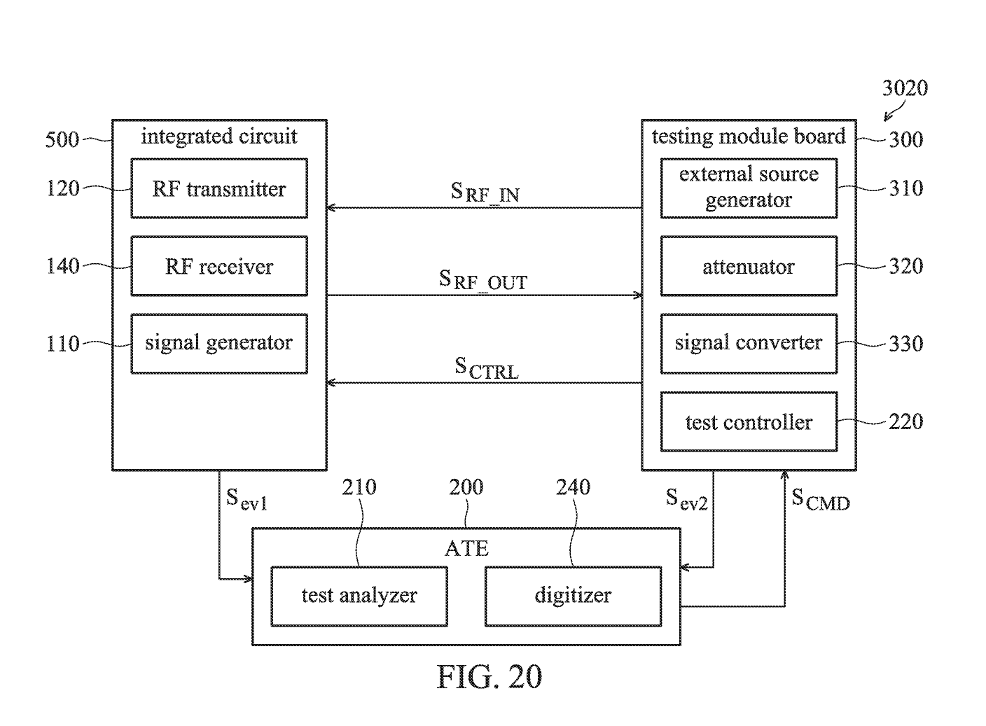

FIG. 20 is a schematic block diagram of an RF testing system 3020 according to still another embodiment of the invention. In the RF testing system 3020, the IC 500 may be a SOC or a stand-alone RF IC, and the circuit configuration and connection of the components in the RF testing system 3020 are similar to those in the RF testing system 3013 except that the test controller 220 has been moved to the testing module board 300. In the embodiment, the ATE 200 is capable of initiating an RF Tx or Rx test process by issuing a command signal (i.e. a digital signal) S_{CMD} to the test controller 220 in the testing module board 300, and the test controller 220 in the testing module board 300 may send the control signals S_{CTRL} to the corresponding components in the IC 500 and the testing module board 300 in response to the command signal S_{CMD}. It should be noted that different RF test configurations, which are previously described in the embodiments of FIGS. 9 to 18, can be used in the RF testing system 3020, and the details can be referred to in the embodiment of FIGS. 9 to 18. Specifically, the test analyzer 210 of the ATE 200 is still responsible for receiving the evaluation signal (i.e. a low-speed analog/digital signal) from either the RF receiver 140 or the signal convertor 330 for digital signal analysis. When the evaluation signal from either the RF receiver 140 or the signal convertor 330 is in analog form, the digitizer 240 of the ATE 200 may convert the evaluation signal into digital signals before the test analysis is performed by the test analyzer 210.

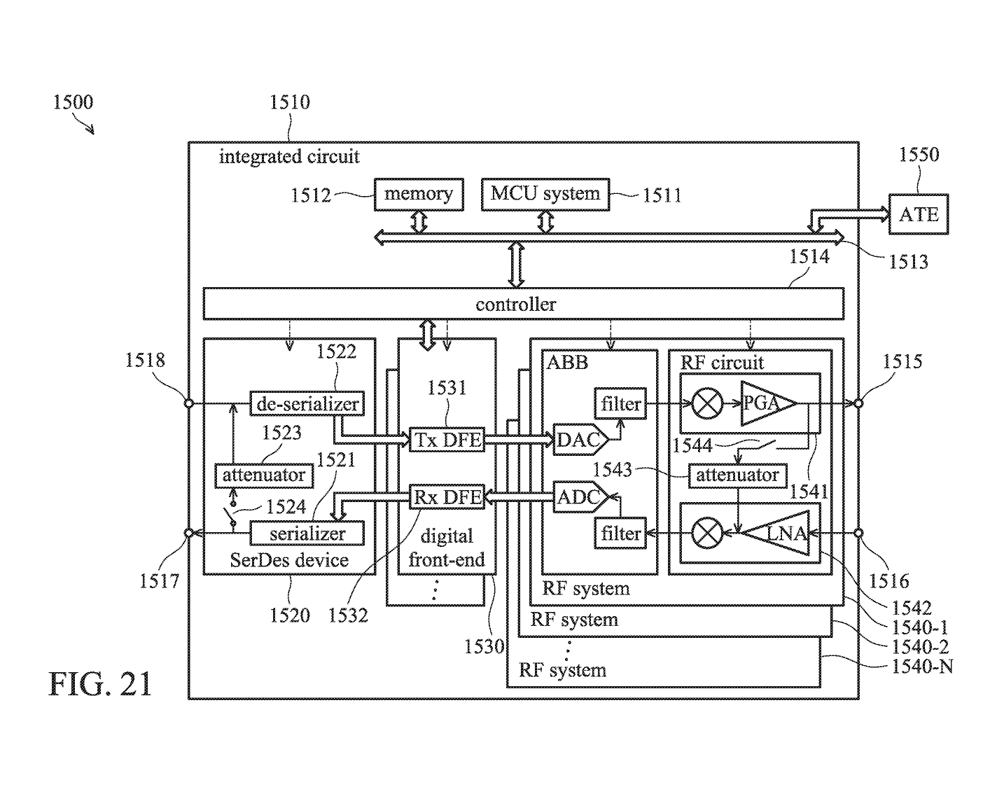

A trend of modern communications techniques (for example, LTE down-link/up-link Carrier Aggregation) is high data transmission speed. A SerDes or serializer/deserializer circuit facilitates the transmission because it can reduce the number of analog or digital pins. FIG. 21 is a diagram of an RF testing system that is capable of testing RF systems and SerDes circuit jointly in accordance with an embodiment of the invention. The RF testing system 1500 includes an integrated circuit 1510 and an ATE 1550. The integrated circuit 1510 includes an MCU system 1511, a memory 1512, a bus 1513, a controller 1514, a SerDes device 1520, a digital front-end (DFE) 1530, and a plurality of RF systems 1540-1˜1540-N. The MCU system 1511, the memory 1512, the controller 1514, and the ATE 1550 communicate with each other through the bus 1513. The MCU system 1511 may comprises one or more central processing units (CPU), digital signal processor (DSP), and/or microcontrollers (MCU). The memory 1512 is configured to store captured test data, and test patterns that are uploaded from the ATE 1550 through the bus 1513. The SerDes device 1520 is configured to serialize a test signal and de-serialize the serialized test signal through an internal path or an external path, so that the de-serialized test signal can be fed into the DFE 1530.

The DFE 1530 corresponds to the RF systems 1540-1˜1540-N, and is configured to perform digital down-conversion, channel-filtering, and sample rate conversion, and the DFE 1530 comprises a Tx DFE 1531 and an Rx DFE 1532 that provide an interface that communicates between the SerDes device 1520 and the RF systems 1540-1˜1540-N.

For example, the MCU system 1511 may generate a test signal according to the test patterns that are uploaded to the memory 1512 by the ATE 1550, and transmit the test signal to the serializer 1521 via the controller 1514. The serializer 1521 then serializes the test signal and transmits the serialized test signal to the deserializer 1522 through the attenuator 1523 (i.e. the switch 1524 is closed, and a closed-loop internal path is selected). Specifically, the test signal passes through the SerDes internal loopback path (i.e. through the attenuator 1523), Tx DFE 1531, RF transmitter 1541, an RF internal loopback path (i.e. through the attenuator 1543), RF receiver 1542, and Rx DFE 1532, and the resulting test signal is captured at the output of Rx DFE 1532 by the MCU system 1511 via the controller 1514. Then, the MCU system 1511 analyzes the quality of the captured resulting test signal to determine a test result, and reports the test result to the ATE 1550. It should be noted that the ATE 1550 does not require any RF instruments for performing the RF tests of the integrated circuit 1510. It should be noted that the SerDes closed-loop path and RF closed-loop path are used in FIG. 21. For example, the SerDes procedure is close-looped internally through the attenuator 1523, and the RF Tx/Rx procedure is close-looped internally through the attenuator 1543.

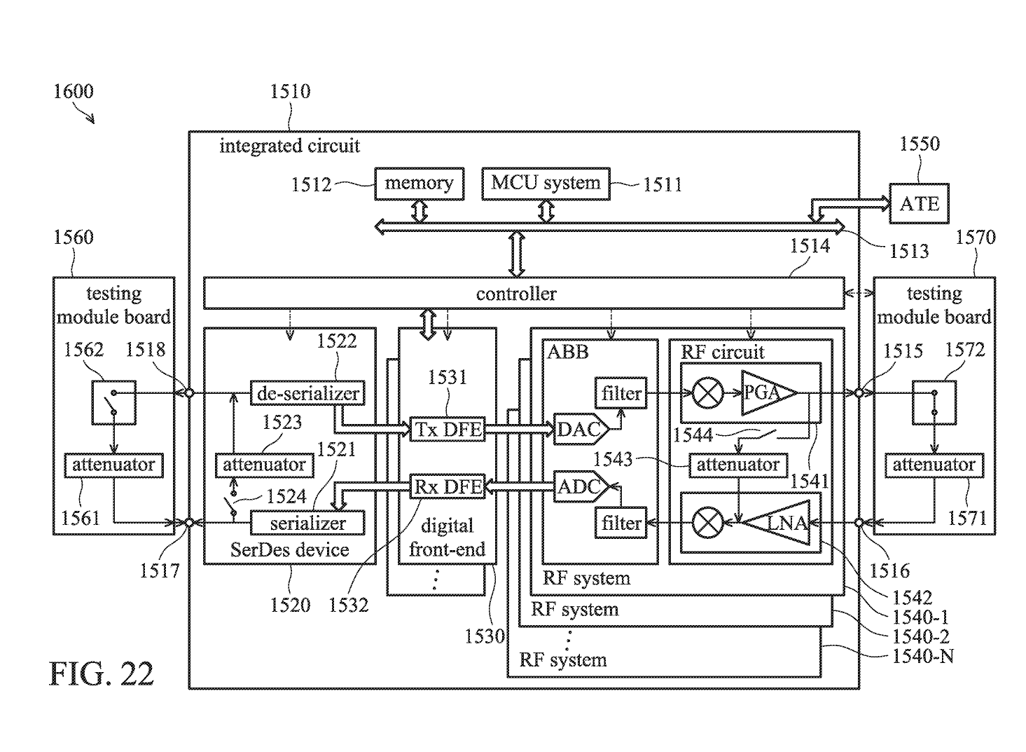

FIG. 22 is a diagram illustrating different test configurations of the RF testing system 1500 in FIG. 21. In some embodiments, the attenuator 1523 in the SerDes device 1520 can be optional, and the attenuator 1543 in the RF systems 1540-1˜1540-N can also be optional. For example, the path from the serializer 1521 to the deserializer 1522 may pass through an external attenuator 1561 of a testing module board 1560 (i.e. the switch 1562 is closed, and the switch 1524 is opened), and this path is regarded as a SerDes external loopback path. Similarly, the path from the RF transmitter 1541 to the RF receiver 1542 may pass through an external attenuator 1571 of a testing module board 1570 (i.e. the switch 1572 is closed, and the switch 1544 is opened). More specifically, there is an external loopback path and an internal loopback path for the SerDes device 1520, and there is also an external loopback path and an internal loopback path for the RF systems 1540-1˜1540-N. However, no matter the external loopback path or the internal loopback path for the SerDes device 1520 is selected and no matter the external loopback path or the internal loopback path for the RF systems 1540-1˜1540-N is selected, the generated test signal can pass through the SerDes device 1520 as well as the RF transmitter 1541 and RF receiver 1542, thereby testing the RF system(s) and the SerDes device jointly to determine whether the overall system is good or bad. It should be noted that the SerDes closed-loop path and RF closed-loop path are used in FIG. 21. For example, the SerDes procedure can be close-looped internally through the attenuator 1523 or externally through the attenuator 1561, and the RF Tx/Rx procedure can be close-looped internally through the attenuator 1543 or externally through the attenuator 1571. It should also be noted that any combination of the internal/external SerDes closed-loop paths and the internal/external RF closed-loop paths can be selected freely by the engineer to test the integrated circuit 1510.

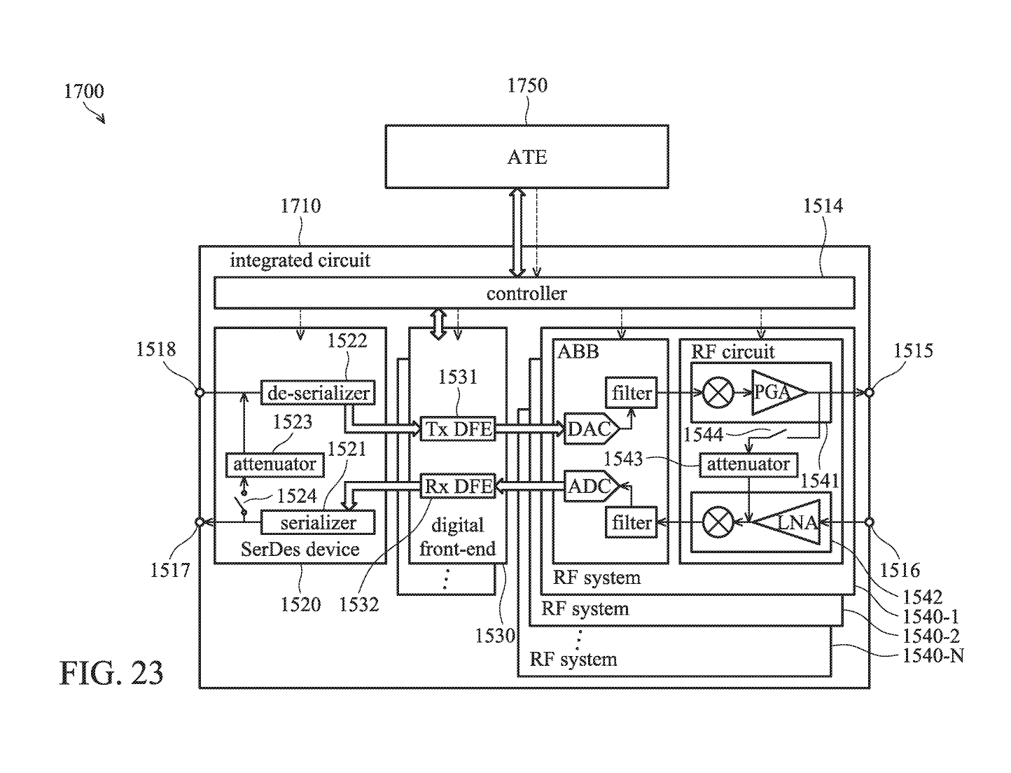

FIG. 23 is a diagram of an RF testing system in accordance with another embodiment of the invention. FIG. 23 illustrates a DSP-less, ATE-aided configuration of an RF testing system. The RF testing system 1700 in FIG. 23 is similar to the RF testing system 1500 in FIG. 21, and the difference between the RF testing systems 1500 and 1700 is that the MCU system and memory are absent in the integrated circuit 1710, and the ATE 1750 is capable of controlling the integrated circuit 1710 (i.e. DUT) via the controller 1514. Specifically, the integrated circuit 1710 is a DSP-less IC, and the test signal is loaded from the ATE 1750, and is transmitted to the serializer 1521. Similarly, the test signal passes through the SerDes internal loopback path (i.e. through the attenuator 1523), Tx DFE 1531, RF transmitter 1541, an RF internal loopback path (i.e. through the attenuator 1543), RF receiver 1542, and Rx DFE 1532. However, the resulting test signal is captured at the output of the Rx DFE 1532, and the captured resulting test signal is sent to the ATE 1750. Then, the ATE 1750 performs a test analysis on the captured resulting test signal to determine a test result. Similarly, the external loopback path(s) may replace the internal loopback path(s), as afore-mentioned.

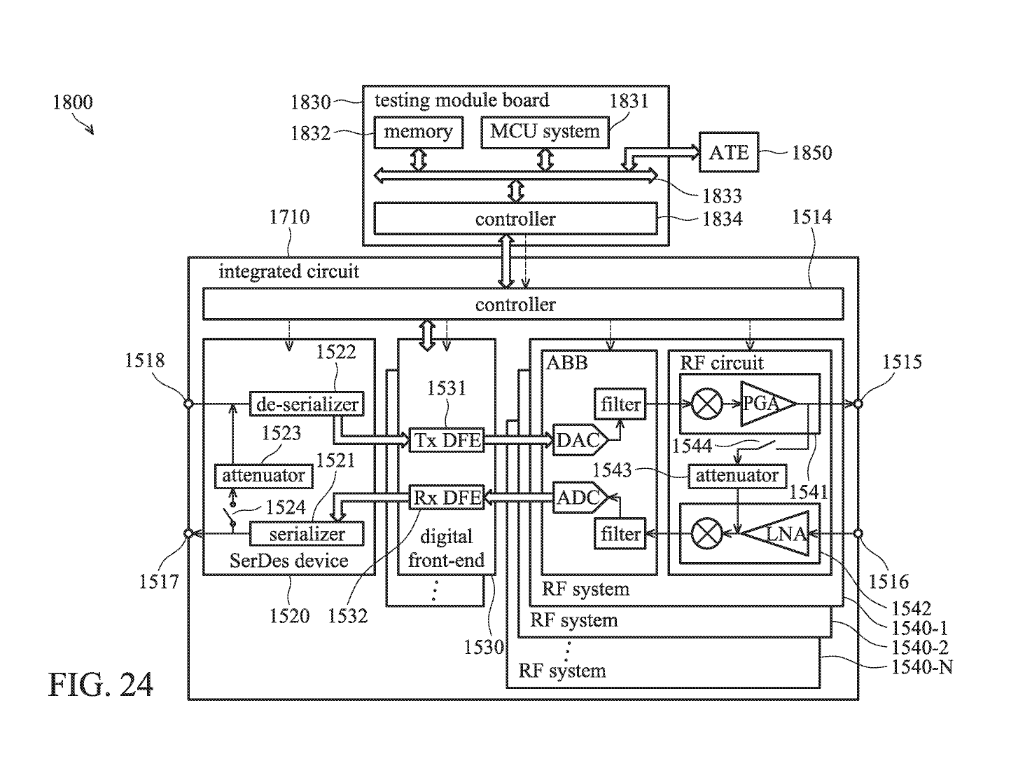

FIG. 24 is a diagram of an RF testing system in accordance with another embodiment of the invention. FIG. 24 illustrates a DSP-less, test-board-aided configuration of an RF testing system. The RF testing system 1800 in FIG. 24 is similar to the RF testing system 1700 in FIG. 23, and the difference between the RF testing systems 1700 and 1800 is that the RF testing system 1800 further comprises a testing module board 1830. The testing module board 1830 comprises an MCU system 1831, a memory 1832, a bus 1833, and a controller 1834. The MCU system 1831, the memory 1832, the controller 1834, and the ATE 1850 communicate with each other through the bus 1833. The ATE 1850 is capable of uploading test patterns to the memory 1832 of the testing module board 1830. The MCU system 1831 may control the integrated circuit 1710 via the controller 1834. More specifically, the MCU system 1831 may generate a test signal according to the test patterns uploaded to the memory 1832, and transmit the test signal to the serializer 1521. Similarly, the test signal passes through the SerDes internal loopback path (i.e. through the attenuator 1523), Tx DFE 1531, RF transmitter 1541, an RF internal loopback path (i.e. through the attenuator 1543), RF receiver 1542, and Rx DFE 1532. The resulting test signal is also captured at the output of the Rx DFE 1532 by the controller 1514, and the captured resulting test signal is transmitted to the memory 1832. The MCU system 1831 may retrieve the captured resulting test signal from the memory 1832, perform a test analysis on the captured resulting test signal to determine a test result, and then transmit the test result to the ATE 1850. Similarly, the external loopback path(s) may replace the internal loopback path(s), as afore-mentioned.

Please be noted that the test signal is not limited to be transmitted to the serializer 1521 and captured at the output of the RX DFE 1532 for RF testing. The test signal can be injected into the test loop at any nodes. However, the node between the serializer 1521 and the RX DFE 1532 is preferred because the test signal can be in digital format with lower data rate/speed.

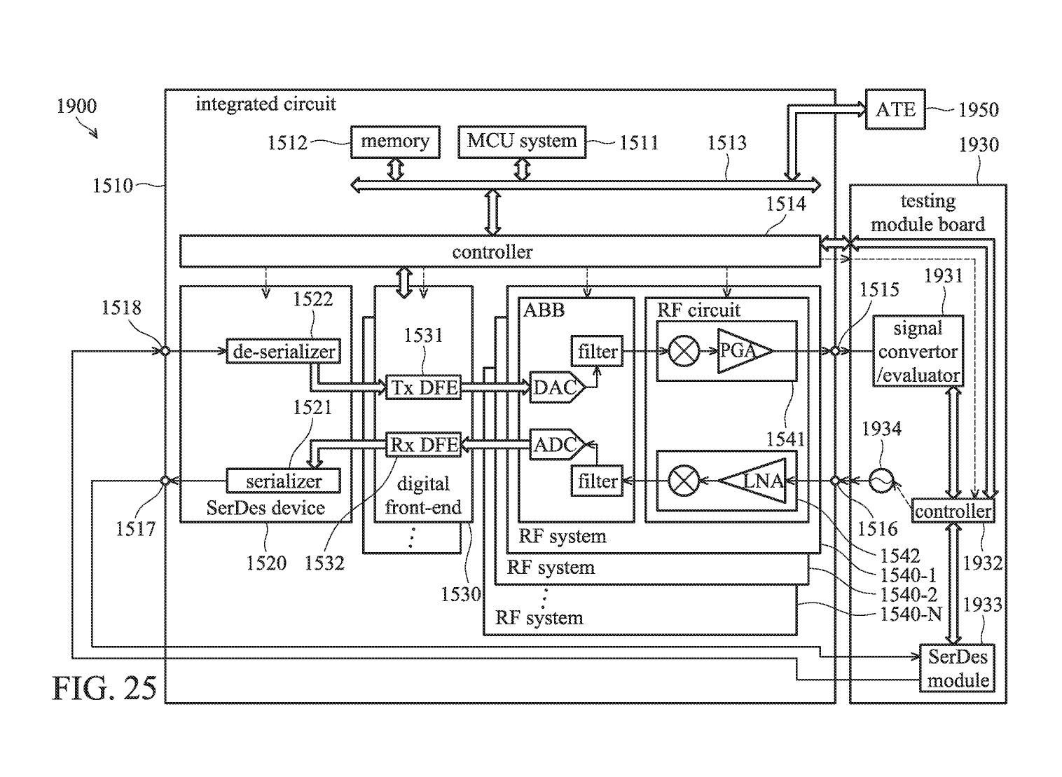

FIG. 25 is a diagram illustrating different test configurations the RF testing system 1900 in accordance with another embodiment of the invention. FIG. 25 illustrates a testing-module-board-aided configuration of an RF testing system. The difference between the RF testing system 1500 in FIG. 21 and the RF testing system 1900 in FIG. 25 is that an external testing module board 1930 is coupled to the integrated circuit 1510 via ports 1515 and 1516. The testing module board 1930 comprises a signal converter and evaluator 1931, a controller 1932, a signal generator 1934, and a SerDes module 1933. The signal converter and evaluator 1931 is capable of performing signal down-conversion and evaluate the quality of the down-converted RF signal. The controller 1932 is capable of controlling components in the testing module board 1930 and communicating with the integrated circuit 1510 through the controller 1514 of the integrated circuit 1510. In an embodiment, the MCU system 1511 is capable of controlling the testing module board 1930 via the controller 1932.

Specifically, while performing an RF Rx test, the MCU system 1511 controls the signal generator 1934 on the testing module board 1930 to generate an RF test signal that is fed into the RF receiver 1542. The test signal passes through the RF receiver 1542, Rx DFE 1532, and the serializer 1521, and the SerDes module 1933 captures the serialized test signal at the output of the serializer 1521, and de-serializes the captured signal. The de-serialized test signal is then transmitted to the integrated circuit 1510 through the controller 1932 of the testing module board 1930. The MCU system 1511 may perform a test analysis on the captured test signal to determine a test result, and then report the test result to the ATE 1950. In this way, the RF RX functionality and the serialization functionality of the integrated circuit 1510 are tested jointly to determine whether the overall functionality is good or bad (e.g., pass or fail).

While performing an RF Tx test, the ATE 1950 uploads test patterns to the memory 1512 of the integrated circuit 1510, and the MCU system 1511 generates a test signal and transmit the test signal to the SerDes module 1933 through the controller 1514 and controller 1932. The serialized test signal is fed into the deserializer 1522 for de-serialization. The de-serialized test signal is then sent to the Tx DFE 1531, and the output RF signal of the RF transmitter 1541 is captured by the signal converter and evaluator 1931. For example, the signal converter and evaluator 1931 may down-convert the output RF signal of the RF transmitter 1541 into a baseband signal, digitize the baseband signal into digital data (e.g. using an ADC), and stores the digital data into the memory 1512. The MCU system 1511 may perform a test analysis on the digital data stored in the memory 1512 to determine a test result, and then report the test result to the ATE 1950. In this way, the RF TX functionality and the de-serialization functionality of the integrated circuit 1510 are tested jointly to determine whether the overall functionality is good or bad (e.g., pass or fail). It should be noted that the SerDes open-looped path and RF open-looped path are used in FIG. 25. For example, the SerDes procedure is performed by the SerDes module 1933 that is external to the integrated circuit 1510, and the RF Tx/Rx procedure is also performed by the signal converter and evaluator 1931, the controller 1932, and the signal generator 1934 that are disposed on the testing module board 1930 external to the integrated circuit 1510.

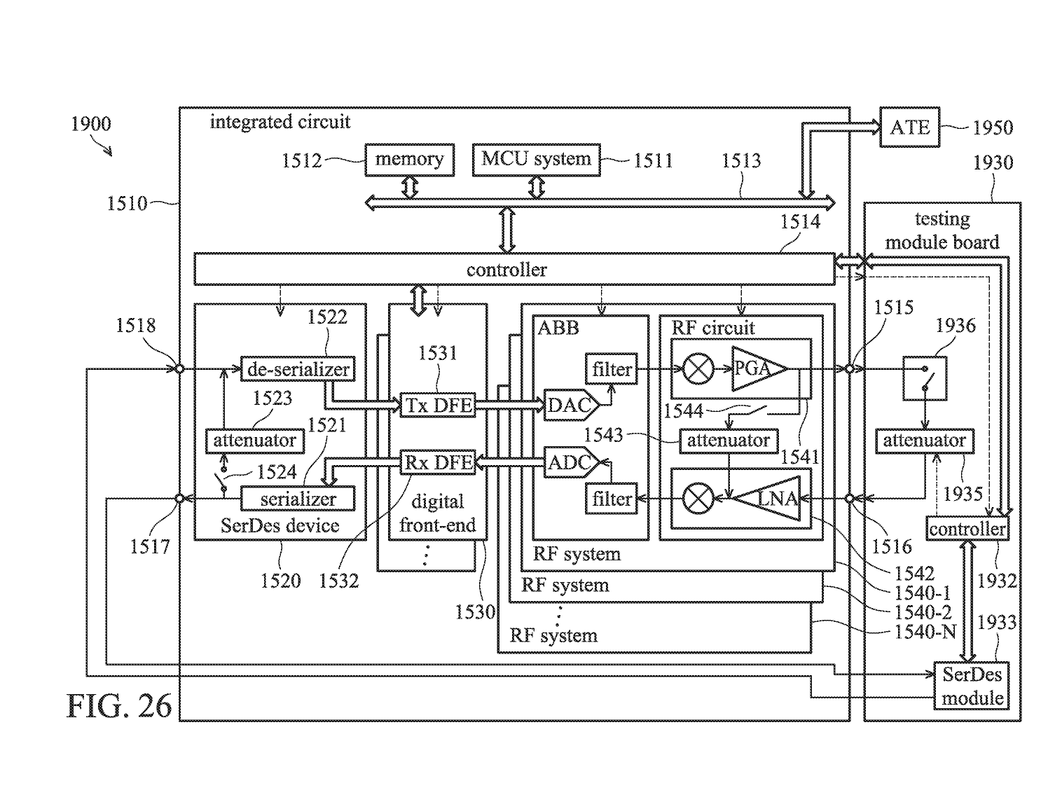

FIG. 26 is a diagram illustrating different test configurations the RF testing system 1900 in accordance with yet another embodiment of the invention. Alternatively, please referring to FIG. 26, the output RF signal of the RF transmitter 1541 can be attenuated by an attenuator 1935 of the testing module board 1930, and the attenuated output RF signal is further fed back into the RF receiver 1542. Accordingly, the controller 1514 may capture the resulting test signal at the output of the Rx DFE 1532, and stores the captured resulting test signal to the memory 1512. The MCU system 1531 may perform a test analysis on the captured resulting test signal to determine a test result, and then report the test result to the ATE 1950.

As shown in FIG. 26, the SerDes device 1520 can be open-looped and the RF closed-loop path (e.g. internal closed-loop path or external closed-loop path) can be used. For example, when the SerDes device 1520 is open-looped, the output test signal of the serializer 1521 is sent to the SerDes module 1933 of the external testing module board 1930 (i.e. switch 1524 is opened), and the SerDes module 1933 performs de-serialization. The de-serialized test signal is then transmitted to the integrated circuit 1510 through the controller 1932 of the testing module board 1930. The MCU system 1511 may perform a test analysis on the captured test signal to determine a test result, and then report the test result to the ATE 1950.

When the RF internal closed-loop path is selected, the output RF signal of the RF transmitter 1541 is attenuated by the internal attenuator 1543 (i.e. switch 1936 is opened), and the attenuated output RF signal is sent to the RF receiver 1542. When the RF external closed-loop path is selected, the output RF signal of the RF transmitter 1541 is attenuated by the external attenuator 1935 of the testing module board (i.e. switch 1936 is closed), and the attenuated output RF signal is sent to the RF receiver 1542.

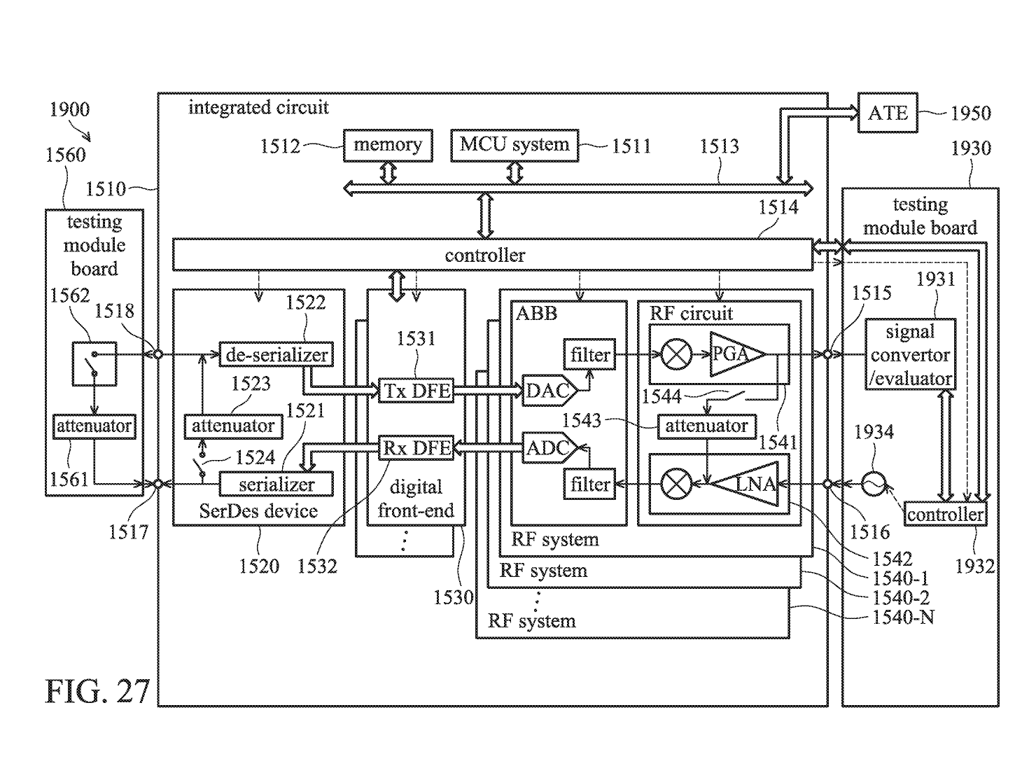

FIG. 27 is a diagram illustrating different test configurations the RF testing system 1900 in accordance with yet another embodiment of the invention. As shown in FIG. 27, the RF testing system 1900 comprises the integrated circuit 1510, the testing module board 1560, and the testing module board 1930. However, no SerDes module is disposed on the testing module board 1930. In FIG. 27, the SerDes close-looped path and the RF open-looped path are used. For example, when the SerDes device 1520 is close-looped, the internal SerDes closed-loop path or the external SerDes closed-loop path can be selected. For example, when the internal SerDes closed-loop path is selected, the output test signal of the serializer 1521 is sent to the de-serializer 1522 through the internal attenuator 1523 (i.e. switch 1524 is closed and switch 1562 is opened), and the de-serializer 1522 performs de-serialization. When the external SerDes closed-loop path is selected, the output test signal of the serializer 1521 is sent to the de-serializer 1522 through the external attenuator 1561 (i.e. switch 1524 is opened and switch 1562 is closed), and the de-serializer 1522 performs de-serialization. The de-serialized test signal is then transmitted to the Tx DFE 1531. Then, the output RF signal of the RF transmitter 1541 is captured by the signal converter and evaluator 1931. For example, the signal converter and evaluator 1931 may down-convert the output RF signal of the RF transmitter 1541 into a baseband signal, digitize the baseband signal into digital data (e.g. using an ADC), and stores the digital data into the memory 1512. The MCU system 1511 may perform a test analysis on the digital data stored in the memory 1512 to determine a test result, and then report the test result to the ATE 1950. In this way, the RF TX functionality and the de-serialization functionality of the integrated circuit 1510 are tested jointly to determine whether the overall functionality is good or bad (e.g., pass or fail).

Accordingly, the designers may verify the functionality of the RF systems using different configurations using the SerDes open-looped or closed-looped path, and RF internal loop-back path or external loop-back path.

In addition, the cost for RF testing can be reduced using the joint RF and SerDes tests with closed-loop and/or open-loop configurations, and the test coverage of the RF testing system can be improved. Furthermore, it's not necessary for the ATE to equip RF instruments, and thus the cost for RF testing can be reduced further.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An integrated circuit (IC), comprising
a controller, configured to obtain a test signal when the IC has entered a test mode;
a serializer-deserializer (SerDes) device, configured to perform a serialization/deserialization process;
a transmitter, configured to perform a radio frequency (RF) transmission process; and
a receiver, configured to perform an RF receiving process;
wherein when the IC enters the test mode, the test signal passes through the SerDes device and at least one of the transmitter and the receiver to generate a resultant test signal for determining a test result.

2. The IC as claimed in claim 1, wherein the controller obtains the test signal from a processor of the IC, and the processor performs a test analysis on the resultant test signal to determine the test result.

3. The IC as claimed in claim 2, wherein the processor generates the test signal according to test patterns from test equipment external to the IC, and reports the test result to the test equipment.

4. The IC as claimed in claim 1, wherein the test signal is generated by test equipment external to the IC, and the test equipment performs a test analysis on the resultant test signal to determine the test result.

5. The IC as claimed in claim 1, wherein the test signal is generated by module circuitry external to the IC, and a processor of the testing module board performs the test analysis on the resultant test signal to determine the test result.

6. The IC as claimed in claim 5, wherein the module circuitry is connected to test equipment that is external to the IC, and reports the test result to the test equipment.

7. The IC as claimed in claim 5, wherein the module circuitry comprises a test signal generator for generating an RF test signal as the test signal to the receiver while performing an RF Rx test in the test mode.

8. The IC as claimed in claim 1, wherein the SerDes device comprises
an attenuator;
a serializer, configured to serialize the test signal and transmit the serialized test signal to the attenuator while performing the SerDes process, wherein the attenuator attenuates the serialized test signal; and
a deserializer, configured to deserialize the attenuated serialized test signal.

9. The IC as claimed in claim 1, wherein the SerDes device is coupled to a module circuitry that is external to the IC and comprises an attenuator, and the test signal is serialized by the SerDes device, attenuated by the attenuator, and de-serialized by the SerDes device.

10. The IC as claimed in claim 1, wherein the SerDes device is coupled to a module circuitry that is external to the IC and comprises a SerDes module, and the SerDes module transmits the test signal to the SerDes device and/or receive the resultant test signal from the SerDes device.

11. The IC as claimed in claim 1, wherein an RF signal generated by the transmitter is attenuated by an internal attenuator of the IC, and then received by the receiver.

12. The IC as claimed in claim 1, wherein the RF transmitter and the RF receiver are coupled to a module circuitry that is external to the IC and comprises an external attenuator, and an RF signal generated by the transmitter is attenuated by the external attenuator and then received by the receiver.

13. A module circuitry for a RF testing system, comprising:
an input port, configured to receive a down-converted and serialized test signal from a device-under-test;
an output port, configured to output a serialized test signal to be de-serialized and up-converted by the device-under-test; and
a SerDes module, configured to de-serialize the down-converted and serialized test signal and to generate the serialized test signal.

14. A module circuitry for a RF testing system, comprising:
an input port, configured to receive a down-converted and serialized test signal from a device-under-test; and
an attenuator, configured to attenuate the down-converted and serialized test signal to generate an attenuated test signal; and
an output port, configured to output the attenuated test signal to be de-serialized and up-converted to the device-under-test.

15. A radio frequency (RF) testing system, comprising:
a test equipment;
a module circuitry; and
an integrated circuit (IC), comprising:
a controller, configured to obtain a test signal when the IC has entered a test mode;
a serializer-deserializer (SerDes) device, configured to perform a serialization/deserialization process;
a transmitter, configured to perform a RF transmission process; and
a receiver, configured to perform a RF receiving process;
wherein when the IC enters the test mode, the test signal passes through the SerDes device and at least one of the transmitter and the receiver to generate a resultant test signal for determining a test result,
wherein the module circuitry is external to the IC and the test equipment.

16. The RF testing system as claimed in claim 15, wherein the test signal is an RF signal or an analog signal.

17. The RF testing system as claimed in claim 15, wherein the test signal is a high-speed digital signal.

18. The RF testing system as claimed in claim 15, wherein the IC further comprises a processor for performing a test analysis on the resultant test signal to determine the test result.

19. The RF testing system as claimed in claim 15, wherein the module circuitry comprises a processor for performing a test analysis on the resultant test signal to determine the test result.

20. The RF testing system as claimed in claim 15, wherein the test equipment performs a test analysis on the resultant test signal to determine the test result.
